(19) United States
(12) Patent Application Publication
(10) Pub. No.: US 2017/0098030 A1
(43) Pub. Date: Apr. 6, 2017

(54) SYSTEM AND METHOD FOR GENERATING DETECTION OF HIDDEN RELATEDNESS BETWEEN PROTEINS VIA A PROTEIN CONNECTIVITY NETWORK

(71) Applicant: OFEK - ESHKOLOT RESEARCH AND DEVELOPMENT LTD, Karmiel (IL)

(72) Inventor: Zakharia FRENKEL, Haifa (IL)

(21) Appl. No.: 15/310,401

(22) PCT Filed: May 11, 2015
(86) PCT No.: PCT/IL2015/050489

§ 371 Date: Nov. 10, 2016

Related U.S. Application Data
(60) Provisional application No. 61/991,540, filed on May 11, 2014.

(51) Int. Cl. G06F 19/24; G06N 99/00

(52) U.S. Cl. CPC G06F 19/24; G06N 99/005

(57) ABSTRACT

Systems and methods are for generating a weighted relatedness protein network. The method includes steps of obtaining a protein network; generating training data; generating a weighting function derived from the training data values; and applying the weighting function to a protein network, thereby generating a weighted relatedness protein network. The protein network may be applied for prediction of protein properties by detection of relatedness with annotated sequences.

### FIELD OF THE INVENTION

The subject matter relates generally to detection of hidden relatedness between proteins via protein networks and more specifically to a system and method for generating and using a weighted protein network.

### BACKGROUND OF THE INVENTION

To establish possible function of a newly discovered protein, alignment of its sequence with other known sequences is required. When the similarity is marginal, the function remains uncertain.

Annotation of the protein sequences requires pair-wise or multiple sequence alignment (Trifonov E. N. & Frenkel Z. M. Evolution of protein modularity. Current Opinion in Structural Biology, 2009; 19, 1-6). When the compared sequences share a high level of identity, the alignment does not pose any problems. The task becomes trouble- some in the case of low identity between the sequences and if several gaps (or, more exactly, indels) are present.

A commonly used approach in such situations is introduction of specific weights (or ‘costs’) for mismatches (substitution matrix) and indels, and search for optimal ‘configuration’, which corresponds to the maximal score. Typically, some statistically evaluated optimal solution is offered. Indeed, every structurally/functionally specific site in the protein should allow only certain correlated types of mutations, which are leveled down when one general substitution matrix is used. Several modifications of the standard method, such as Position-Specific Iterated BLAST (PSI-BLAST) or Compositionally Adjusted Substitution Matrices do improve the alignment, but do not solve the problem.

The Intermediate Sequence Search (ISS) technique was successfully applied for detecting marginally similar pairs of proteins (Park J., Teichmann, S. A., Hubbard, T. & Chothia, C. Intermediate sequences increase the detection of homology between sequences. Journal of Molecular Biology, 1997; 273, 349-354). The ISS approach “links” proteins that do not show significant sequence similarity between them, but are both detectably related to a third protein—intermediate sequence. However, this approach is limited since it is also based on sequence comparison between proteins.

### SUMMARY OF THE INVENTION

It is thus one object of the present invention to disclose a method for generating a weighted relatedness protein network comprising steps of:
a. obtaining a protein network; said protein network comprises a plurality of protein sequences;
b. generating training data comprising steps of;
   i. obtaining a plurality of protein sequences from a preexisting protein database;
   ii. reducing redundancy of said plurality of protein sequences;
   iii. dividing the protein sequences into a plurality of subsequences;
   iv. defining a threshold value for protein sequence similarity;
   v. generating a plurality of pairs of said subsequences, said subsequence pairs having a protein similarity value equal or above said predefined threshold;
   vi. defining training data parameters for weighting relatedness between said subsequence pairs;
   vii. calculating the values of said training data parameters for said subsequence pairs;
c. generating a weighting function derived from said training data values; and
d. applying said weighting function to a protein network, thereby generating a weighted relatedness protein network.

It is a further object of the present invention to disclose the method as defined above, wherein said protein subsequence comprises between about 15 to about 25 amino acids.

It is a further object of the present invention to disclose the method as defined in any of the above, additionally comprising steps of selecting said preexisting protein database from a database classification group consisting of: structural, functional categories, physiological role, gene type, EC scheme, taxonomy of genes, taxonomy of pathways, taxonomy of reactions, taxonomy of ligand/compound, subcellular localization, protein classes, protein complexes, phenotypes, pathways, genetic element type, cellular role, molecular environment, genetic properties, post translational modifications, gene identification list, protein design and mutant stability and affinity prediction (EGAD), cellular roles, metabolic classification, cellular component, process, phylogenetic classification database and any combination thereof.

It is a further object of the present invention to disclose the method as defined in any of the above, additionally comprising steps of selecting said preexisting protein database from a group consisting of protein data bank (PDB), the Research Collaboratory for Structural Bioinformatics (RCSB) PDB, ASTRAL, Database of Macromolecular Movements, Dynameomics, JenaLib, ModBase, OCA, KEGG: Genes, KEGG: Pathways, KEGG: Ligand/Compound, KEGG: Ligand/Enzyme, WIT, OMIM, PDB select, Pfam, PubMed, SCOP, SwissProt, OPM, PDBe, PDB Lite, PDBsum, PDBTM, PDBWiki, ProtCID, Protein, Proteopedia, ProteinLounge, SWISS-MODEL Repository, TOPSAN, UniProt, Swiss-Prot, UniProtKB/Swiss-Prot, ExPASy, PANTHER, BioLiP, STRING, ProFunc, PROTEOME database, database of Clusters of Orthologous Groups of proteins (COG), Enzyme Commission number (EC number) database, GenProtEC, EcoCyc, MIPS: MYGD, MIPS: MATD, PEDANT, Proteome.com: YDP and WormPD, MGI: Mouse Genome Database (MGD), TIGR: Microbial databases TIGR: Expressed Gene Anatomy Database, EGAD, Gene Ontology, Institute Pasteur SubtiList, Institute Pasteur TubercuList, Sanger Centre and any combination thereof.

It is a further object of the present invention to disclose the method as defined in any of the above, additionally comprising steps of selecting said training data parameters for relatedness between said subsequence pairs from a group consisting of: functional similarity, structural similarity, spectral clustering, sequence similarity, solubility, hydrophobicity, electrical conduction, evolutionary ranking and any combination thereof.

It is a further object of the present invention to disclose the method as defined in any of the above, additionally comprising steps of calculating said structural similarity by a measure selected from the group consisting of: root mean square deviation (RMSD), exponent of minus squared dissimilarity divided by squared standard deviation, variance measure, probability distribution function, secondary structure assignment, native contact maps, residue interaction patterns, measures of side chain packing, measures of hydrogen bonds retention , dihedral angles of the protein backbones, minRMS, secondary structure elements (SSEs), TM-score, TM-align, protein 3D structure alignment, Residue physic-chemical properties and any combination thereof.

It is a further object of the present invention to disclose the method as defined in any of the above, additionally comprising steps of calculating said sequence similarity of said subsequence pairs by calculating the sequence similarity within said subsequence pairs, calculating the sequence similarity between sequences adjacent to said subsequence pairs or by a combination thereof.

It is a further object of the present invention to disclose the method as defined in any of the above, additionally comprising steps of calculating said sequence similarity of said subsequence pairs or adjacent sequences thereof by parameters selected from the group consisting of number of mismatches, hamming distance, position of mismatches relative to the subsequence, sequence complexity, number of repeating amino acids, existence of indels, position specific scoring matrix, hidden Markov Model, Markov Random Field, amino acid properties, similarity to corresponding genetic DNA sequences and any combination thereof.

It is a further object of the present invention to disclose the method as defined in any of the above, additionally comprising steps of selecting said amino acid properties from the group consisting of size, polarity, hydrophobicity, charge, H-bonding and any combination thereof.

It is a further object of the present invention to disclose the method as defined in any of the above, additionally comprising steps of calculating said sequence similarity by a measure selected from the group consisting of: hamming distance, sequence alignment, BLAST, FASTA, SSEARCH, GGSEARCH, GLSEARCH, FASTM/S/F, NCBI BLAST, WU-BLAST, PSI-BLAST and any combination thereof.

It is a further object of the present invention to disclose the method as defined in any of the above, wherein said step of generating a function derived from said training data values additionally comprises steps of interpolating the zero values.

It is a further object of the present invention to disclose the method as defined in any of the above, additionally comprises steps of interpolating the zero values by substituting the zero values by average values of neighboring non zero values.

It is a further object of the present invention to disclose the method as defined in any of the above, wherein said step of generating a weighting function derived from said training data values additionally comprises steps of selecting said weighting function from the group consisting of: discrete form and continuous form.

It is a further object of the present invention to disclose the method as defined in any of the above, additionally comprising steps of selecting said weighting function from the group consisting of: a table of average protein similarity values calculated for said predetermined training data parameters, linear regression, monotonic regression, spline interpolation, discrete spline interpolation, polynomic approximation equation and any combination thereof.

It is a further object of the present invention to disclose the method as defined in any of the above, additionally comprising steps of smoothing data of said discrete form function via an approximating function selected from a group consisting of: averaging, linear transformation, spline interpolation, monotonic regression, algorithms, density estimator, histogram, smoother matrix, convolution, moving average algorithm, scale space representation, additive smoothing, Butterworth filter, Digital filter, Kalman filter, Kernel smoother, Laplacian smoothing, Stretched grid method, Low-pass filter, Savitzky-Golay smoothing, Local regression, Smoothing spline, Ramer-Douglas-Peucker algorithm, Exponential smoothing, Kolmogorov-Zurbenko filter and any combination thereof.

It is a further object of the present invention to disclose the method as defined in any of the above, wherein each of said plurality of subsequences is represented by a node in the protein network.

It is a further object of the present invention to disclose the method as defined in any of the above, additionally comprises steps of calculating a plurality of distances between said nodes, said distance is calculated according to a protein similarity property.

It is a further object of the present invention to disclose the method as defined in any of the above, wherein said distance is calculated by a hamming distance function between said pair of subsequences represented by the two nodes.

It is a further object of the present invention to disclose the method as defined in any of the above, additionally comprises steps of generating an edge between two nodes in the network when said hamming distance between the two nodes is lower than a predefined threshold hamming distance value for said protein similarity property.

It is a further object of the present invention to disclose the method as defined in any of the above, wherein said edges in the network are calculated according to sequence similarity values of adjacent sequences to the nodes of said edge.

It is a further object of the present invention to disclose the method as defined in any of the above, wherein said preexisting protein database comprises proteins with known structure.

It is a further object of the present invention to disclose the method as defined in any of the above, wherein said weighting function is configured to calculate the distances of the edges in the network.

It is a further object of the present invention to disclose the method as defined in any of the above, wherein said weighting function is derived from dependency of structural similarity attributes to similarity of sequences attributes.

It is a further object of the present invention to disclose the method as defined in any of the above, further comprises steps of adding a fake edge to the protein network, said fake edge is correlated with a known protein similarity to a protein subsequence represented by a node in the protein network.

It is a further object of the present invention to disclose the method as defined in any of the above, further comprises steps of calculating protein similarity values to said fake edge.

It is a further object of the present invention to disclose the method as defined in any of the above, further comprises steps of converting the distances representing the edges into electrical attributes.

It is a further object of the present invention to disclose the method as defined in any of the above, wherein said electrical attributes comprises resistance values.

It is a further object of the present invention to disclose the method as defined in any of the above, further comprises steps of defining weighted protein relatedness based on resistance values between said subsequence pairs of said protein network.

It is a further object of the present invention to disclose the method as defined in any of the above, further comprises steps of providing structural and/or functional annotation of a protein sequence by calculating the weighted relatedness between said protein sequence and annotated sequences.

It is a further object of the present invention to disclose the method as defined in any of the above, further comprises steps of ranking a plurality of distances between a predetermined protein subsequence and annotated protein fragments.

It is a further object of the present invention to disclose the method as defined in any of the above, additionally comprising steps of calculating sequence similarity in about 10 amino acid upstream and downstream said subsequence pairs.

It is a further object of the present invention to disclose the method as defined in any of the above, wherein said protein sequence similarity threshold is about 60% sequence similarity.

It is a further object of the present invention to disclose the method as defined in any of the above, additionally comprises steps of
a. adding to said protein network additional nodes, wherein each of said additional nodes comprises protein fragments of about 20 aa derived from an annotated protein sequence database, and
b. generating a plurality of pairs of said additional nodes and between said additional nodes and said protein network plurality of sequences, said pairs having a protein similarity value equal or above said predefined threshold.

It is a further object of the present invention to disclose a method for generating a weighted relatedness protein network comprising steps of:
a. obtaining a protein network;
b. generating training data comprising steps of;
   i. obtaining a plurality of protein sequences with a known structure from a preexisting database;
   ii. reducing redundancy of said plurality of protein sequences;
   iii. dividing the protein sequences into a plurality of sub-sequences;
   iv. defining a threshold value for protein sequence similarity;
   v. generating a plurality of pairs of said subsequences, said subsequence pairs having a sequence similarity value above said predefined threshold;
   vi. calculating training data comprising steps of:
      1. calculating the root mean square deviation (RMSD) value of structural similarity between each of said pairs of subsequences;
      2. calculating sequence similarity value between each of said pairs of subsequences and/or sequence similarity value between upstream and downstream sequences of said subsequences;
c. generating a weighting function derived from said training data configured for calculating weighted resistance between protein sequences;
d. applying said weighting function to a protein network, thereby generating a weighted resistance protein network.

It is a further object of the present invention to disclose a method for predicting the degree of structural similarity of protein sequences comprising steps of:

a. obtaining a plurality of protein sequences;

b. dividing the protein sequences into a plurality of protein subsequences comprising 15 to 25 amino acids;

c. plotting average RMSD values of said subsequence pairs against amount of sequence mismatches in said fragment pairs;

d. plotting average RMSD values of said subsequence pairs against amount of sequence mismatches upstream and downstream sequences of said fragment pairs;

e. calculating the dependence of the amount of sequence matches of said subsequence pairs against the amino acid distance from said subsequence;

It is a further object of the present invention to disclose a method for predicting structural similarity of proteins comprising steps of
a. obtaining at least two predetermined protein sequences;
b. dividing the at least two protein sequences into a plurality of protein fragments comprising 15 to 25 amino acids;
c. defining a threshold value for protein sequence similarity;
d. generating a plurality of pairs of said fragments, said fragment pairs having a sequence similarity value above said predefined threshold;
e. calculating the slope of amount of sequence matches against amino acid distance from said 15 to 25 amino acid fragment thereby determining degree of similarity of said 15 to 25 amino acid fragments.

It is a further object of the present invention to disclose a method for facilitating generating a weighted relatedness protein network comprising steps of:
a. obtaining a protein network;
b. generating training data comprising steps of;
   i. obtaining a plurality of protein sequences from a preexisting protein database;
   ii. reducing redundancy of said plurality of protein sequences;
   iii. dividing the protein sequences into a plurality of subsequences;
   iv. defining a threshold value for protein similarity;
   v. generating a plurality of pairs of said subsequences, said subsequence pairs having a protein similarity value equal or above said predefined threshold;
   vi. defining training data parameters for relatedness between said subsequence pairs;
   vii. calculating the values of said training data parameters for said subsequence pairs;
c. generating a weighting function derived from said training data values said weighting function configured for calculating weighted relatedness of protein sequences.

It is a further object of the present invention to disclose the method as defined in any of the above, additionally comprising steps of applying said weighted relatedness function to a protein network, thereby generating a weighted relatedness protein network.

It is a further object of the present invention to a method for optimizing predictions of structural similarity between proteins comprising steps of:
a. obtaining a protein network;
b. generating training data comprising steps of;
   i. obtaining a plurality of protein sequences with a known structure from a preexisting database;
   ii. reducing redundancy of said plurality of protein sequences;
   iii. dividing the protein sequences into a plurality of sub-sequences;
   iv. defining a threshold value for protein sequence similarity;
   v. generating a plurality of pairs of said subsequences, said subsequence pairs having a sequence similarity value above said predefined threshold;
   vi. calculating training data comprising steps of:
      1. calculating the root mean square deviation (RMSD) value of structural similarity between each of said pairs of subsequences;
      2. calculating the sequence similarity value in predetermined sized adjacent sequences of said subsequence pairs;
c. generating a weighting function derived from said training data configured for calculating weighted resistance between protein sequences;
d. applying said weighting function to said protein network;
e. plotting the number of correct structural similarity predictions against the size of said adjacent sequences taken into account in step 2, thereby obtaining a predictive power curve, peak of said curve defining optimal size of adjacent sequences needed to provide maximum correct predictions.

It is a further object of the present invention to disclose a non transitory computer readable medium comprising instructions which, when implemented by one or more computers cause the one or more computers to present at a display unit of said one or more computers at least one of the following:
a. average RMSD values against amount of mismatches in 15 to 25 amino acid fragment pairs;
b. average RMSD values against amount of mismatches in upstream and downstream sequences of said fragment pairs;
c. slope of amount of sequence matches of said 15 to 25 amino acid fragment pairs against amino acid distance from said fragment; thereby determining degree of similarity of said 15 to 25 amino acid fragment pairs.

It is a further object of the present invention to disclose a non transitory computer readable medium comprising instructions which, when implemented by one or more computers cause the one or more computers to present at a display unit of said one or more computers:
a weighting function derived from training data values, said training data values are calculated comprising steps of:
   a. obtaining a plurality of protein sequences from a preexisting protein database;
   b. reducing redundancy of said plurality of protein sequences;
   c. dividing the protein sequences into a plurality of subsequences;
   d. defining a threshold value for a predetermined protein similarity property;
   e. generating a plurality of pairs of said subsequences, said subsequence pairs having a protein similarity value equal or above said predefined threshold;
   f. defining training data parameters for weighting relatedness between said subsequence pairs;
   g. calculating the values of said training data parameters for said subsequence pairs;

said weighting function configured for calculating weighted relatedness of protein sequences.

It is a further object of the present invention to disclose the non transitory computer readable medium as defined in any of the above, wherein said weighting function is applicable to any protein network, thereby generating a weighted relatedness protein network.

It is a further object of the present invention to disclose a method for improving the prediction power of a preexisting protein network, comprising steps of:
a. obtaining a protein network; said protein network comprises a plurality of nodes, each of said nodes comprises a protein sequence fragment of between about 15 aa to about 25 aa;
b. generating training data comprising steps of;
   i. obtaining a plurality of protein sequences from a preexisting protein database;
   ii. reducing redundancy of said plurality of protein sequences;
   iii. dividing the protein sequences into a plurality of subsequences;
   iv. defining a threshold value for protein sequence similarity;
   v. generating a plurality of pairs of said subsequences, said subsequence pairs having a protein similarity value equal or above said predefined threshold;
   vi. defining training data parameters for weighting relatedness between said subsequence pairs;
   vii. calculating the values of said training data parameters for said subsequence pairs;
c. generating a weighting function derived from said training data values;
d. adding to said protein network additional nodes, wherein each of said additional nodes comprises protein fragments of about 20 aa derived from an annotated protein sequence database;
e. generating a plurality of pairs of said additional nodes and said protein network plurality of sequences, said pairs having a protein similarity value equal or above said predefined threshold; and
f. applying said weighting function to said protein network comprising said additional nodes, thereby improving the prediction power of said protein network.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a network of protein sequences, according to some exemplary embodiments of the subject matter;

FIG. 2 shows a method for analyzing protein sequences via a network, according to some exemplary embodiments of the subject matter;

FIG. 3 shows backbone structures of two protein fragments. Corresponding sequences of these fragments having low similarity, but having good connection via the network, as demonstrated in FIG. 4, according to some exemplary embodiments of the subject matter;

FIG. 4 shows a relatedness via network of two protein fragments with sequences having low similarity, but correspondent 3D structures are similar, as shown in FIG. 3 according to some exemplary embodiments of the subject matter;

FIG. 5 shows backbone structures having a high similarity, for corresponding nodes referenced in FIG. 6 according to some exemplary embodiments of the subject matter;

FIG. 6 demonstrates adding of additional ‘effective’ edge between two nodes correspondent to protein fragments with similar structures (shown in FIG. 5). This additional edge would significantly decrease a resistance between these nodes and an intermediate network region selected by circle, according to some exemplary embodiments of the subject matter;

FIG. 7 graphically illustrates the dependence of average RMSD values on 20 aa fragment pairs similarity;

FIG. 8 graphically illustrates the dependence of average RMSD values on the similarity of sequences adjacent to the 20 aa protein fragments;

FIG. 9 graphically illustrates the dependence of amount of matches on the amino acid position distance (N) from the compared 20 aa fragments, for structurally similar (RMSD <3A) fragments;

FIG. 10 graphically illustrates the dependence of amount of matches on the amino acid position distance (N) from the compared 20 aa fragments, for structurally dissimilar (RMSD >3A) fragments;

FIG. 11 graphically illustrates the amount of correct predictions of the current weighting protein relatedness model against the aa size (N) of sequences adjacent to the protein fragments of interest taken into account, relative to previous non-weighted model;

FIG. 12A graphically illustrates the influence of the position of matches in adjacent sequences to the protein fragments of interest on average RMSD differences;

FIG. 12B graphically illustrates the influence of the position of matches in adjacent sequences to the protein fragments of interest on average RMSD differences, when each plot is of a preselected total number of mismatches in downstream and upstream adjacent aa sequences; and

FIG. 13 presents a method for generating a weighted relatedness protein network, according to some alternative exemplary embodiments of the subject matter.

### DETAILED DESCRIPTION OF THE INVENTION

The biological functions of proteins are uniquely defined by their amino acid sequence. But exactly how this correspondence is established remains a problem of protein sequence analysis to be solved.

The present invention is directed towards the determination of properties, for example, 3D structure, the biological role and mechanism of functioning, of any protein of interest by just reading its sequence, in order to save a good deal of effort, resources and research time, as well as discover new ways to solve many problems of molecular biology and medicine. Questions such as: What is the function encoded by a newly found sequence? Is it similar to already known proteins? Can analogies be drawn between existing sequences and their corresponding properties? Are fundamental ones, and unfortunately, existing research techniques often fall short in answering them and as a result, many sequences are left without annotations.

The present invention is directed towards development and implementation of a novel approach for protein sequence annotation, via Protein Connectivity Network in sequence space (PCN). As inter alia demonstrated, this approach is significantly more powerful than all existing methods for protein annotation.

According to main aspects, the present invention is designed and adapted for common use by pre-calculations and storage of huge sequence comparison data as well as involvement of advanced algorithms for analysis of ultra large graph Data Bases. Correspondingly the present disclosure solves these computational problems by application of network clustering algorithms together with physical modeling, considering the graph as a system of water-flow tubes and/or as electrical conducting network. Finally, a functional verification of the predictions generated by the network is carried out.

It is further within the scope that by using the novel tool and method provided by the present invention, the number of unidentified proteins in the databases will be dramatically reduced.

Without wishing to be bound by theory, the present invention is based on the assumption that most of the proteins are composed by evolutionary conserved modules of standard size of about 25-30 amino-acid residues. Typically, these modules appear as closed loops.

It is further submitted that the sequences of the protein modules are highly variable while their functions and structures are rather conserved. This sequence diversity of the modules accumulated during the evolutionary process has been a major obstacle to the reliable detection of such modules through sequence analysis. A solution for this problem is proposed by the present invention: the relatedness of the variable sequences is represented by the networks in natural protein sequence space.

The present invention, surprisingly, detects homology between small conserved protein modules, instead of full protein, as was done by the initial Intermediate Sequence Search (ISS) approach, which opened a new era in sequence analysis.

It is demonstrated by the novel approach of the present invention that small protein segments (about 20aa) can form long ‘walks’ or ‘paths’ in a protein sequence space. The ‘walk’ is herein defined as a chain of sequence fragments, where each element of the path (i.e. sequence fragment) has high similarity to its neighbors. A combination of ‘walks’ forms a network.

Contrary to random sequence space of the same size, the sequence walks in natural space are significantly longer. It is unexpectedly shown that in many instances the 3D-structure and function of the initial fragment is conserved through the walk, despite sequence changes.

It is further within the scope that the selection of an appropriate size for each segment or element is a crucial condition for building of such a network. It is shown by the publication of Frenkel Z. M. & Trifonov E.N. Walking through protein sequence space. Journal of Theoretical Biology, 2007; 244, 77-80, which is incorporated herein in it's entirety, that for other sizes, the construction of such a network is impossible: for the larger sizes the sequence fragments contain several conserved modules. As a consequence, the approach will detect only ‘trivial’ relatedness, also detectible by other methods. For the smaller sizes the protein fragment properties are rather depending on neighboring sequences, which also render the application of the present method meaningless, as in these cases, the commonly used Blast (http://blast.ncbi.nlm.nih.gov/Blast.cgi) procedure for sequence alignment can be used.

It should be emphasized, that although several other researches also considered construction of different protein networks, the ignorance of existence of an optimal sequence size for the network construction made their approaches inapplicable for detection of hidden homology.

The present invention discloses means and methods for generating a weighted relatedness protein network. The aforementioned method comprises steps of: (a) obtaining a protein network; (b) generating training data; (c) generating a weighting function derived from the training data values; and (d) applying the weighting function to a protein network, thereby generating a weighted relatedness protein network. This protein network may be applied for prediction of protein properties by detection of relatedness with annotated sequences.

According to one embodiment, the present invention provides a method for generating a weighted relatedness protein network comprising steps of: (a) obtaining a protein network; (b) generating training data; (c) generating a weighting function derived from said training data values; and (d) applying said weighting function to a protein network, thereby generating a weighted relatedness protein network.

It is according to main aspects of the invention that the step of generating training data further comprises steps of; (i) obtaining a plurality of protein sequences from a preexisting protein database; (ii) reducing redundancy of said plurality of protein sequences; (iii) dividing the protein sequences into a plurality of subsequences; (iv) defining a threshold value for protein sequence similarity; (v) generating a plurality of pairs of said subsequences, said subsequence pairs having a protein similarity value equal or above said predefined threshold; (vi) defining training data parameters for weighting relatedness between said subsequence pairs; and (vii) calculating the values of said training data parameters for said subsequence pairs.

The presently disclosed subject matter provides means and methods for generating and analyzing a network of protein sequences represented via electronic models or properties. The protein network is generated according to similarities between various protein sequences that are represented in the network. The network of the subject matter provides reliable annotation for many cases in which all other existing methods are inefficient and thus opens new possibilities of protein clustering. The protein network enables better prediction of protein properties, as elaborated below

A further core aspect of the present invention is to generate an improved protein network or in other words to improve the prediction power of preexisting protein networks. This is carried out by adding to a given protein connectivity network (PCN), additional nodes (i.e. protein fragments) derived from annotated protein sequence database, such as ASTRAL database (proteins with known structure) or SWISS-PROT database (proteins with known functions). This step is especially important when the given PCN comprises only a limited group of proteins and therefore its predictive power is also limited.

As used herein the term “about” denotes ±25% of the defined amount or measure or value.

The term “protein network” also defined as “protein connectivity network” or “PCN” generally refers to a plurality of protein sequences represented by nodes. A node in the network represents a protein sequence or a fragment or subsequence thereof. A node in the network may be bound by edges to one or more other protein sequences represented by nodes in the network. It is within the scope that the network approach of the present invention is configured to determine the role of a specific amino acid sequence or protein or its relatedness to other proteins with respect to its structure, function or annotation. Without wishing to be bound by theory, networks may simplify complex systems by splitting the system into a series of links. In the context of the present invention, links represent the neighboring protein sequences or nodes that may be connected by edges.

As used herein, the term “node” or “sequence fragment” or “protein fragment” or “sub-sequence” refers hereinafter to a protein sequence or a part thereof comprising about 15 to 25 amino acids, particularly about 20 amino acids.

The term “reduce redundancy” refers hereinafter to the reduction of duplicated design decisions in user interface complexity when a single feature or hypertext link is presented in multiple ways. In the context of the present invention, the term refers to the reduction of repeats in the training data. Such repeats may cause inaccuracy in the calculation of the average or expected values.

The term “root-mean-square deviation (RMSD)” refers hereinafter to the measure of the average distance between the atoms (usually the backbone atoms) of superimposed proteins. In the study of globular protein conformations, one customarily measures the similarity in three-dimensional structure by the RMSD of the Ca atomic coordinates after optimal rigid body superposition.

The term “hamming distance” refers hereinafter to the number of positions between two strings of equal length at which the corresponding symbols are different. In other words, it measures the minimum number of substitutions required to change one string into the other, or the minimum number of errors that could have transformed one string into the other. In the context of the present invention the term string refers to a protein sequence or protein fragment, preferably comprising about 20 amino acids and the terms position or symbol refers to a single amino acid within the protein fragment or sequence.

The term “protein sequence space” refers hereinafter to a representation of all possible sequences or sequences existing in nature for a protein. It is herein acknowledged that the sequence space has one dimension per amino acid in the sequence leading to highly dimensional spaces. In such a sequence space each protein sequence is adjacent to all other sequences that can be produced through a single mutation. It should be noted that despite the diversity of protein superfamilies, the common protein sequence space is extremely sparsely populated by functional proteins. Most random protein sequences have no fold or function. Enzyme superfamilies, therefore, exist as tiny clusters of active proteins in a vast empty space of non-functional sequence.

The term “formatted protein sequence space” means here that all considered sequences are of the same size (preferably comprising about 20 amino acids for our case).

The present invention provides a network in formatted protein sequence space, which is herein defined as protein connectivity network (PCN). The PCN is constructed by nodes, which comprises 20 amino acid fragments, and edges, which are reflecting a relatively low hamming distance between corresponding fragments. A small hamming distance is herein defined as having a sequence identity which is above a predetermined threshold, such as high sequence identity of about 60% and more.

According to one aspect, the most important property of the herein disclosed network is the existence of long ‘paths’ or ‘walks’ in which protein sequences gradually change from one to completely different one, while conserving the structural and functional properties of the corresponding protein fragments.

As used herein, the term ‘paths’ or ‘walks’ is herein defined as a chain of sequence fragments, where each element of the path (i.e. sequence fragment) has high similarity to its neighbors. It is further within the scope that a combination of walks forms a network.

The term “edge” is defined hereinafter as sufficiently high sequence-wise similarity between the protein fragments of corresponding nodes to satisfy a predefined threshold. According to a specific embodiment, an edge is defined as amino acid sequence similarity of 60% or more.

The term “fake edge” refers herein after to cases, when annotations of different not-neighboring nodes are similar and thus fake edges between such nodes are added to the network before calculation of the resistances through the network, in order to increase connectivity between the nodes correspondent to protein fragments with potentially similar annotations.

The term “relatedness” or “resistance” refers hereinafter to similarity or dissimilarity between protein fragments or sequences determined according to predefined weights or properties.

The similarity value between the nodes corresponding to the protein sequence fragments in the network may be determined according to a hamming distance between two protein sequence fragments. If this value is higher or equal than some selected threshold, for example 60% of identity, the nodes are connected by edge and become neighboring.

According to a further embodiment, relatedness between the protein fragments can be detected via connection between corresponding nodes through the PCN. The probability of two fragments to be similar (independently of their sequences) strongly depends on an amount of alternative paths (flow) and length of these paths.

According to a further embodiment, the present invention uses an electrical model for defining relatedness through the network. This approach takes into account the network parameters, as they directly influence on an electric properties that represents the connectivity through the network. Such properties include conductivity or, oppositely, resistance.

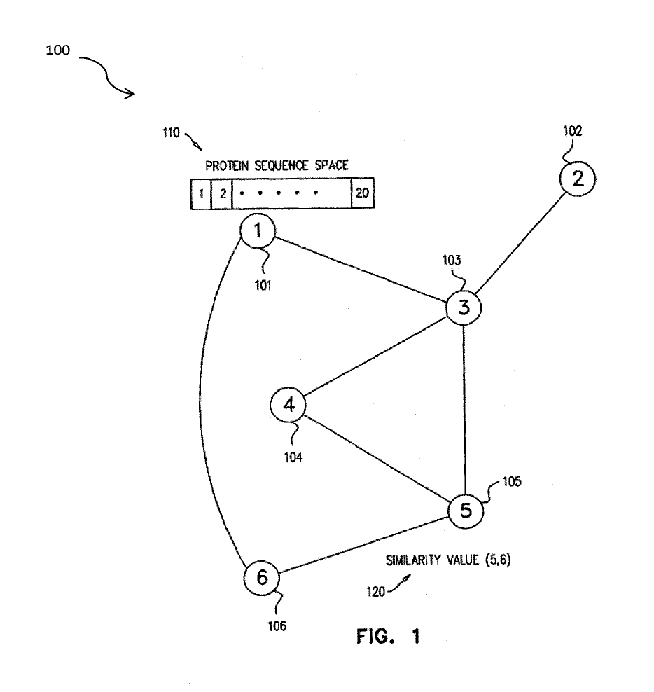

FIG. 1 shows a network of protein sequences, according to some exemplary embodiments of the subject matter. Each node in the network 100 represents a fragment of a protein sequence of having a size of about 15-25 amino acids. The network 100 enables in-depth analysis concerning different proteins in the network, based on the difference between various proteins connected to each other via the network.

The network 100 comprises a plurality of nodes 101, 102, 103, 104, 105, 106. The number of nodes in the network 100 is the number of protein sequence fragments inputted into a computerized system designed for the network analysis. Some of the nodes in the network 100, for example represented by node 101, have known properties and characteristics, and the characteristics of the specific protein will be discovered according to the analysis of the network 100, as detailed below.

The nodes in the network 100 are represented by protein sequence, such as sequence 110. The length of the sequence may be in the range of 15 to 25 amino acids, for example 20 amino acids. The similarity value between the nodes in the network 100 may be determined according to a hamming distance between two protein sequence fragments. If this value is higher or equal than some selected threshold, for example 60% of identity, the nodes are connected by edge and become neighboring. The similarity value is calculated and stored for each pair of neighboring nodes. In addition to hamming distance, the similarity value may be determined according to other mathematical manipulations desired by a person skilled in the art, as long as the values that assemble the protein sequences are the input to such function. After the network 100 is built, resistances are calculated for each of the edges according to the several parameters, such as hamming distance between a pair of nodes connected by each edge. It can therefore be understood that the less the resistance, the greater the similarity. High sequence similarity confers high probability of similarity of other properties. The resistance function can for example take into account similarity of sequences adjacent to the fragments corresponding to nodes, in addition to similarity of the fragments. To summarize, similarity value 120 represents the similarity or relatedness between the protein sequences of nodes 105 and 106.

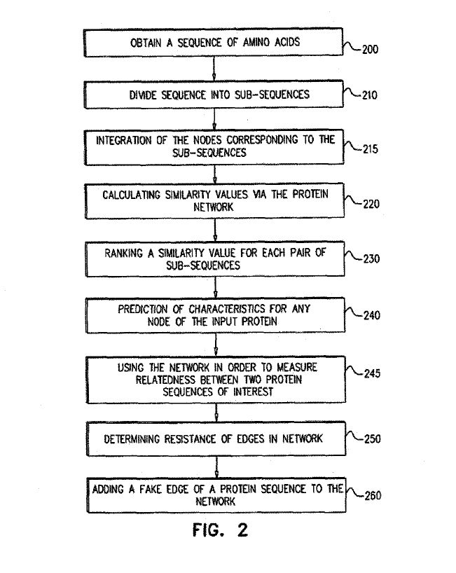

FIG. 2 illustrates a block diagram of a method for analyzing a network of protein sequences, according to some exemplary embodiments of the subject matter. Step 200 discloses obtaining an amino acid sequence of at least one protein or a part thereof. Step 210 discloses dividing the protein sequence into sub-sequences or fragments comprising between about 15 amino acids (aa) and about 25 aa. For example, in case the sequence comprises 40 symbols, the division into sub-sequences is defined by the first sub-sequence comprises symbols number 1-20, the second sub-sequence comprises symbols number 2-21 and the 21^{st} sub-sequence comprises symbols number 21-40. It is further within the scope that other methods for dividing the sequence may be defined by a person skilled in the art.

Step 215 discloses integration of the nodes corresponding to the sub-sequences obtained in step 210, into the network, i.e. as described in FIG. 1. In specific embodiments, part of the protein fragments has available annotations. The integration is made by creating new edges between these nodes and nodes of the network according to some of the definitions described above (i.e. if the similarity value is higher or equal than a predefined threshold, for example 60% of identity, the nodes are connected by an edge).

Step 220 discloses calculating similarity values via the protein network between these subsequences with other subsequences from annotated proteins. Calculation of the distance or the similarity value may be performed in various methods desired by a person skilled in the art, for example by calculation of resistance between the correspondent nodes through the network. In a specific case the resistance is calculated as follows:

(1) An electrical voltage of 1V between the nodes of interest is considered.

(2) The electrical current i between the nodes is calculated. The current through the network may be calculated by the Ohm's and Kirchhoff's current laws.

(3) The resistance through the network of each individual edge is calculated as described above, by similarity between sequences. The resistance through the network is further calculated by dividing the voltage by the current through the network.

In some cases, when annotations of different not-neighboring nodes are similar, fake edges between such nodes are added to the network before calculation of the resistances through the network in order to increase connectivity between the nodes correspondent to protein fragments with potentially similar annotations.

Step 230 discloses ranking the similarity values obtained in 220 between the nodes that should be annotated and other nodes with available annotation. Ranking is performed for each node that should be annotated according to the resistance through the network as calculated in step 220. Plurality of resistance values are ranked, as the smallest resistance is assigned as a high probability to be similar to the node to be annotated.

Step 240 discloses outputting data from the network analysis. The outputted data may be the most similar annotated node for any node of the input protein. The output may also be integrating results of predictions from multiple nodes that have overlapping fragments in order to define properties of the entire protein. For example, in case the overlapping nodes have an overlapping portion of predicted structure that is the same, the prediction can be united to further examine the structure of the entire protein.

Step 245 discloses using the network in order to measure relatedness between two protein sequences of interest, instead of finding an annotation for one protein. In such case the output will be description of the closest (in terms of electronic attributes) pairs of 20-amino acid fragments that belong to the two (or sometimes more) proteins without having annotation of those fragments.

In step 250, the resistance of each edge is determined, according to the values of the two protein fragments connected by the edge, said resistance was used in step 220. The resistance may be calculated by a function representing an expected root mean square deviation (RMSD) between the connected protein sequences in a 3D-structure.

According to certain aspects of the invention, there are two main approaches for definition of resistance function on the basis of the parameters of similarity:

A. An expected RMSD between 3D structures correspondent to sequence fragments of the neighboring nodes;

B. An alternative approach is the selection of a threshold for structural similarity between the fragments, for example 3A. Each structure of the neighboring nodes is considered as ‘similar’ if RMSD <3A, and ‘different’ otherwise. The resistance can be calculated for each set of parameters (X and Y) for example as a probability of fragments with such parameters of similarity to be different.

The calculation of the resistance function can be done by two main approaches:

A. Formula presentation. The function may be written, for example, in a polynomial representation (i.e. Taylor series):

R=a₀₀+a₁₀*X+a₀₁*Y+a₂₀*X²+a₁₁*X*Y+a₀₂*Y²+. . . +aₖ₀*X^{k}+aₖ₋₁₁X^{k-1}*Y+. . . +a₁ₖ₋₁*X*Y^{k-1}+a₀ₖ*Y^{k}=RMSD

Where: R denotes resistance, X for example, can denote amount (proportion) of mismatches in 20 amino acid fragments correspondent to nodes, Y for example, can denote amount of mismatches (proportion) in correspondent adjacent sequences, aᵢⱼ, denote polynomial (Taylor) coefficients (these parameters should be determined). It should be noted that other parameters such as ‘X’ and ‘Y’ can be similarly added.

In order to calculate the RMSD function, preselected training data of protein sequences with known properties, should be used.

To determine the polynomial coefficients (aᵢⱼ), the RMSD function is calculated by calculating X and Y for each pair of 20 amino acid protein fragments derived from some selected training data, i.e. a database of proteins with known properties, for example, 3D structure. According to certain aspects, the protein fragments can be derived from ASTRAL database (containing non-redundant set of proteins with known 3D-structure). It is further within the scope that the protein fragments have been divided into pairs having sequence identity of 60% or more (i.e. the threshold defining the edge in the PCN). Additional filtration of the database to reduce redundancy (such as proteins with the identical SCOPe classification codes etc.) may be carried out.

After taking enough samples (depends on selected training data size) a collection of data which allows calculating the set of the parameters aᵢⱼ, by for example simple linear regression model with least-squares estimation is obtained. The obtained set of the coefficients is used for calculation of resistance for each edge of the network.

B. The function can be presented as a table of expected values of calculated similarly by (A).

Step 260 discloses adding a fake edge of a protein sequence to the network 100. The resistances of the fake edges connecting the nodes of the proteins with known and similar properties can be assigned, for example, in accordance with RMSD between corresponding nodes with known protein structure. A non limiting example of a protein network is the following network:

A1-X1-O-X2-A2,

where A1 and A2 are nodes with identical 3D-structure; O—the node that should be characterized; X1 and X2 represent some not-annotated nodes. Defining, for simplicity, that the resistance between the nodes R(A1-X1-O) equals the resistance between the nodes R(A2-X2-O). It is shown that after introducing a new edge A1-A2 with R(A1-A2)=0, and calculating the resistance between A1 and O, according to Ohm's low for parallel connection:

1/R(A1-O)=1/R(A1-X1-O)+1/(R(A1-A2)+R(A1-X1-O))

The result is R(A1-O)=R(A1-X1-O)/2. Thus it is shown that the new model with the fake edge has doubled relatedness between A1 and O. The approach can be applied for all other configurations of the PCN.

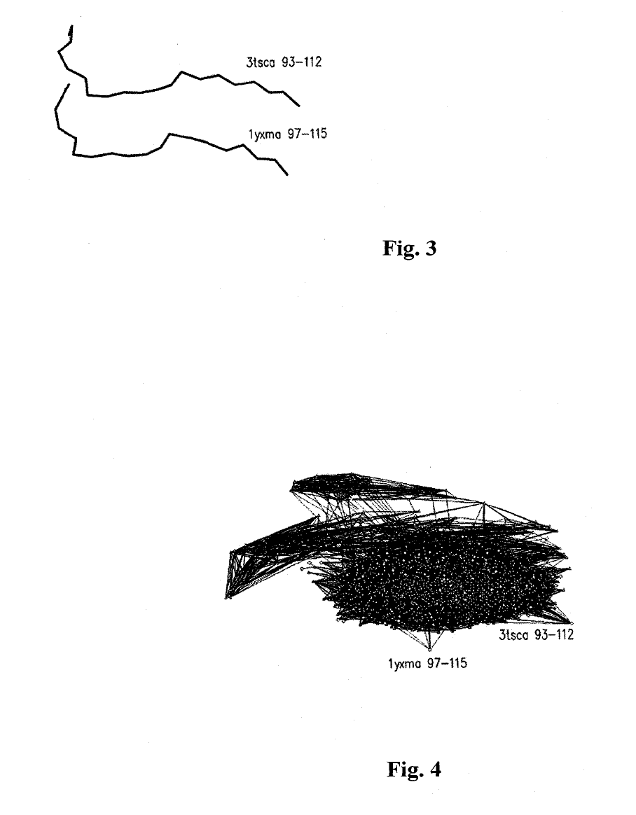

Reference is now made to FIGS. 3-4 illustrating the effectiveness of detection of hidden relatedness between two protein sequences. The two sequences do not seem similar but have a good connection via the PCN (very small resistance) which imply that they have a similar structure.

FIG. 3 shows a backbone structure of two protein fragments with sequences having low similarity, according to some exemplary embodiments of the subject matter. The 20-amino acid fragments are derived from proteins with Protein Data Bank (PDB) codes 3tsc (chain A, starting position ALA 93) and lyxm (chain A, starting position ASP 96). These proteins have similar fold, and the RMSD (root-mean-square-deviation) function between the structures of the fragments is 0.85A, meaning that the structures are very similar, as shown in FIG. 4. However, the two fragment sequences are substantially different (only four matches), as shown below, although the RMSD provides a positive indication as to the similarity between the two sequences. The two sequences are detailed below:

3tsc (A: 93-112)
aalgrldiivanagvaapqa
...|.....|.|.|......
dtfgkinflvnngggqflsp
1yxm (A: 97-115)

FIG. 4 shows a relatedness network comprising the two sequences having low similarity, according to some exemplary embodiments of the subject matter. The graph shows that the relatedness between these two sequences can be determined via the Protein Connectivity Network (PCN) of the present invention. The resistance between the nodes corresponding to the aforementioned sequences, calculated as described above, is only 0.28 which represents a relatively high probability of the relatedness between the two protein sequences.

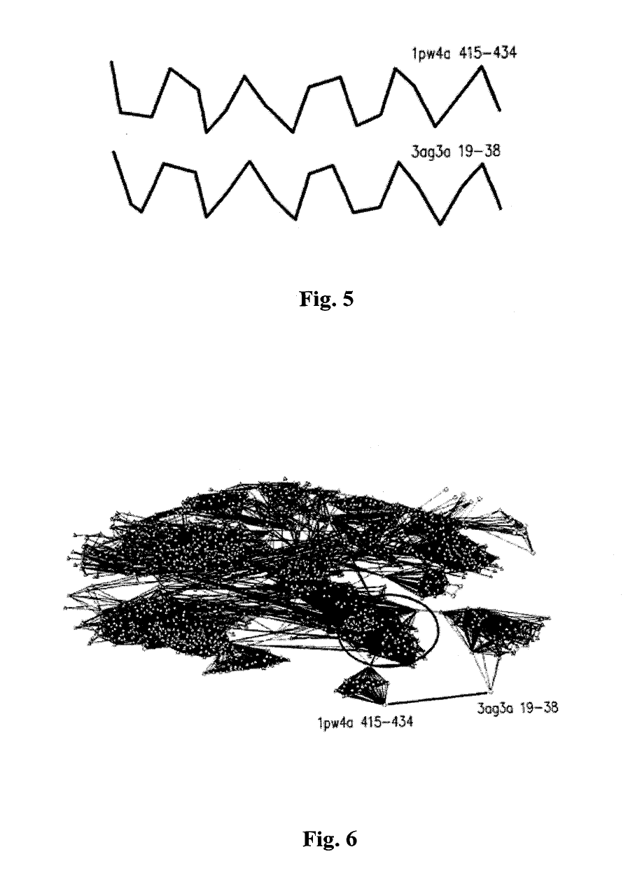

Reference is now made to FIGS. 5-6 showing the effectiveness of adding a fake edge in order to improve annotation of a node in the herein disclosed network.

FIG. 5 shows a high similarity of backbone structure of two 20 amino acid protein fragments with low sequence similarity (see below), according to some exemplary embodiments of the subject matter. The fragments are from proteins with different structural folds: 1pw4 (chain A, starting position GLY 415) and 3ag3 (chain A, starting position TYR 19). The correspondent sequences have only one match and their RMSD value which is 1.01, represents high similarity, and the resistance is 1.85 (higher than the previous example). The sequence comparison is shown below:

1pw4 (A 415-434)
gfmvmiggsilavillivvm
..............|.....
yllfgawagmvgtalsllir
3ag3 (A 19-39)

FIG. 6 shows that a generation of an additional fake edge between the nodes with similar annotation decreases a resistance between these annotated nodes and intermediate part of the network (marked by a circle). This is reflected in an increased probability of correspondent fragments from this part to be with the same 3D structure. It is shown that the computerized method of the present invention may utilize the additional fake edge and use characteristics of the fake edge in order to extract data of other nodes in the protein network. The electric properties of the fake edge can be defined according to structural similarity (RMSD) of correspondent protein fragments, connected by the edges, as well as according to similarity of other characteristics available for the protein fragments.

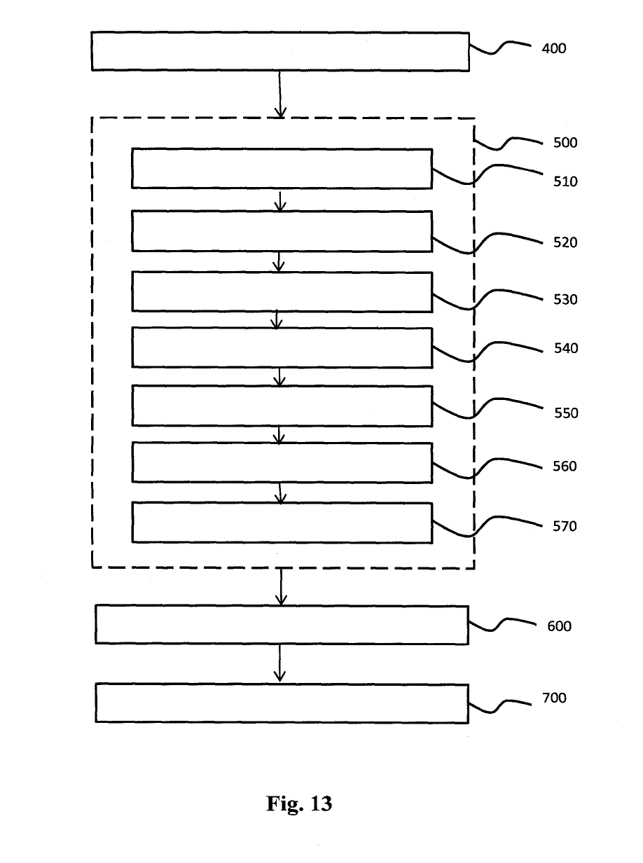

Reference is now made to FIG. 13, presenting an exemplary method for generating a weighted relatedness protein network. The aforementioned method comprises the following steps:

Step 400 discloses obtaining a protein network;

Step 500 discloses generating training data. The training data generation includes the following steps:

Step 510 of obtaining a plurality of protein sequences from a preexisting protein database;

Step 520 discloses reducing redundancy of said plurality of protein sequences;

Step 530 discloses dividing the protein sequences into a plurality of subsequences;

Step 540 of defining a threshold value for protein sequence similarity;

Step 550 of generating a plurality of pairs of said subsequences, said subsequence pairs having a protein similarity value equal or above said predefined threshold;

Step 560 of defining training data parameters for weighting relatedness between said subsequence pairs;

Step 570 discloses calculating the values of said training data parameters for said subsequence pairs;

The aforementioned method further comprises step 600 of generating a weighting function derived from the training data values; and

Step 700 of applying said weighting function to a protein network, thereby generating a weighted relatedness protein network.

Thus, according to one embodiment, the present invention provides a method for generating a weighted relatedness protein network comprising steps of: (a) obtaining a protein network; (b) generating training data; (c) generating a weighting function derived from said training data values; and (d) applying said weighting function to a protein network, thereby generating a weighted relatedness protein network.

According to certain aspects, the step of generating training data comprises steps of; (a) obtaining a plurality of protein sequences from a preexisting protein database; (b) reducing redundancy of said plurality of protein sequences; (c) dividing the protein sequences into a plurality of subsequences; (d) defining a threshold value for protein sequence similarity; (e) generating a plurality of pairs of said subsequences, said subsequence pairs having a protein similarity value equal or above said predefined threshold; (f) defining training data parameters for weighting relatedness between said subsequence pairs; and (g) calculating the values of said training data parameters for said subsequence pairs.

It is further within the scope to provide the method as defined in any of the above, wherein said protein subsequence comprises between about 15 to about 25 amino acids.

It is further within the scope to disclose the method as defined in any of the above, additionally comprising steps of selecting said preexisting protein database from a database classification group consisting of: structural, functional categories, physiological role, gene type, EC scheme, taxonomy of genes, taxonomy of pathways, taxonomy of reactions, taxonomy of ligand/compound, subcellular localization, protein classes, protein complexes, phenotypes, pathways, genetic element type, cellular role, molecular environment, genetic properties, post translational modifications, gene identification list, protein design and mutant stability and affinity prediction (EGAD), cellular roles, metabolic classification, cellular component, process, phylogenetic classification database and any combination thereof.

It is further within the scope to disclose the method as defined in any of the above, additionally comprising steps of selecting said preexisting protein database from a group consisting of protein data bank (PDB), the Research Collaboratory for Structural Bioinformatics (RCSB) PDB, ASTRAL, Database of Macromolecular Movements, Dynameomics, JenaLib, ModBase, OCA, KEGG: Genes, KEGG: Pathways, KEGG: Ligand/Compound, KEGG: Ligand/Enzyme, WIT, OMIM, PDB select, Pfam, PubMed, SCOP, SwissProt, OPM, PDBe, PDB Lite, PDBsum, PDBTM, PDBWiki, ProtCID, Protein, Proteopedia, ProteinLounge, SWISS-MODEL Repository, TOPSAN, UniProt, Swiss-Prot, UniProtKB/Swiss-Prot, ExPASy, PANTHER, BioLiP, STRING, ProFunc, PROTEOME database, database of Clusters of Orthologous Groups of proteins (COG), Enzyme Commission number (EC number) database, GenProtEC, EcoCyc, MIPS: MYGD, MIPS: MATD, PEDANT, Proteome.com: YDP and WormPD, MGI: Mouse Genome Database (MGD), TIGR: Microbial databases TIGR: Expressed Gene Anatomy Database, EGAD, Gene Ontology, Institute Pasteur SubtiList, Institute Pasteur TubercuList, Sanger Centre and any combination thereof.

It is further within the scope to disclose the method as defined in any of the above, additionally comprising steps of selecting said training data parameters for relatedness between said subsequence pairs from a group consisting of: functional similarity, structural similarity, spectral clustering, sequence similarity, solubility, hydrophobicity, electrical conduction, evolutionary ranking and any combination thereof.

It is emphasized that in the described examples the weighted resistances or relatedness is defined as expected structural similarity (or dissimilarity) between protein fragments of correspondent sequences. In those examples the similarity was calculated via root mean square deviation (distance)—RMSD. However, protein relatedness can be defined or calculated by other methods, as described herein below.

It is acknowledged that there is multiplicity of different approaches and tools for quantitative comparison of protein structures (for example, see the publication “Toward more meaningful hierarchical classification of protein three-dimensional structures”, A. May, Prot. Struct. Funct. Genet., (1999) 37, 20-29; and “Comprehensive Evaluation of Protein Structure Alignment Methods: Scoring by Geometric Measures”, R. Kolodny, P. Koehl and M. Levitt; J. Mol. Biol. (2005) 346, 1173-1188, incorporated herein in their entirety). Other definitions of protein relatedness used in the present invention are based on comparison of secondary structure elements, dihedral angles of the protein backbones, methods caring out a procedure similar to sequence alignment for a structural alphabet, calculation of RMSD between subgroups of atoms (minRMS), searching of minimal surface between the virtual backbones, and other conventional methods for calculating protein similarity.

It is thus within the scope to disclose the method as defined in any of the above, additionally comprising steps of calculating said structural similarity by a measure selected from the group consisting of: root mean square deviation (RMSD), variance measure, probability distribution function, secondary structure assignment, native contact maps, residue interaction patterns, measures of side chain packing, measures of hydrogen bonds retention , dihedral angles of the protein backbones, minRMS, secondary structure elements (SSEs), TM-score, TM-align, protein 3D structure alignment, Residue physic-chemical properties and any combination thereof. The resistance can be set as expected structural difference itself, or as a function dependent on this difference, for example exponent of minus squared dissimilarity divided by squared standard deviation, or other.

It is further within the scope to disclose the method as defined in any of the above, additionally comprising steps of calculating said sequence similarity of said subsequence pairs by calculating the sequence similarity within said subsequence pairs, calculating the sequence similarity between sequences adjacent to said subsequence pairs or by a combination thereof.

Generally, for the weighted resistances definition can be used expected parameters of other protein characteristics, not only structural similarities.

It is according to some aspects of the invention that weighted protein relatedness can be calculated by multiplicity of different approaches and tools for protein functional classification (reviewed in “Comparison of functional annotation schemes for genomes”, S. C. Rison, T. C. Hodgman, & J. M. Thornton, Funct. Integr. Genomics. (2000) 1, 56-69), which is incorporated herein in it's entirety. In other examples, comparison of EC codes of enzymes, KEGG pathway based classification codes, and other conventional protein classifications can be used. It can be also done by comparison of COG codes based on a phylogenetic classification.

In addition, physical characteristics of the protein fragments can be also used, such as solubility, hydrophobicity, electrical conduction and other protein characteristics.

According to one embodiment, the weighted resistance is calculated as expected dissimilarity of the protein fragments. Alternatively, a probability of two fragments to be similar/dissimilar (i.e. for selected threshold of similarity) can be used.

According to other embodiments, for calculation or prediction of the weighted resistances (i.e. expected RMSD), estimation of the sequence similarity based on mismatches (i.e. Hamming distances) between the sequences of the PCN nodes and between their adjacent sequences, was used.

According to a further embodiment, the positions of the matches can be taken into account. For example, the matches from adjacent sequences which are closer to the node fragments would be more significant for protein similarity prediction. According to another example, if most of the matches of the node sequences are concentrated at one side of the fragment (i.e. upstream or downstream), the significance of such matches will be reduced.

According to a further embodiment, the complexity of the sequences can be taken into account (the sequences with highly repeated amino acids have increased probability for matches, so such matches would less influence protein similarity).

According to a further embodiment, the existence of indels can be taken into account.

According to a further embodiment, the multiplicity of BLAST-related methods facilitated by position-specific scoring matrix, Hidden Markov Model, recently suggested Markov Random Fields (see, for example, “MRFalign: Protein Homology Detection through Alignment of Markov Random Fields” J. Ma, S. Wang, Z. Wang, J. Xu. (2014). PLoS Comput Biol 10(3):e1003500, which is incorporated herein in it's entirety), can be applied to the sequence comparison.

According to a further embodiment, the amino acid properties (size, polarity, hydrophobicity, charge, H-bonding, and so on) can be taken into account.

According to a further embodiment, the similarity of corresponding genetic DNA sequences can be taken into account.

It is further within the scope to disclose the method as defined in any of the above, additionally comprising steps of calculating said sequence similarity of said subsequence pairs or adjacent sequences thereof by parameters selected from the group consisting of number of mismatches, hamming distance, position of mismatches relative to the subsequence, sequence complexity, number of repeating amino acids, existence of indels, position specific scoring matrix, hidden Markov Model, Markov Random Field, amino acid properties, similarity to corresponding genetic DNA sequences and any combination thereof.

It is further within the scope to disclose the method as defined in any of the above, additionally comprising steps of selecting said amino acid properties from the group consisting of size, polarity, hydrophobicity, charge, H-bonding and any combination thereof.

It is further within the scope to disclose the method as defined in any of the above, additionally comprising steps of calculating said sequence similarity by a measure selected from the group consisting of: hamming distance, sequence alignment, BLAST, FASTA,

SSEARCH, GGSEARCH, GLSEARCH, FASTM/S/F, NCBI BLAST, WU-BLAST, PSI-BLAST and any combination thereof.

It is further within the scope to disclose the method as defined in any of the above, wherein said step of generating a function derived from said training data values additionally comprises steps of interpolating the zero values.

According to a further aspect, when the function of the resistance is a matrix of values containing zeros (i.e. cases of absence in training data), the method as defined in any of the above, additionally comprises steps of interpolating the zero values by substituting the zero values by average values of neighboring non zero values.

It is further within the scope to disclose the method as defined in any of the above, wherein said step of generating a weighting function derived from said training data values additionally comprises steps of selecting said weighting function from the group consisting of: discrete form and continuous form.

It is herein acknowledged that there are several ways for building the weighted resistance function on the basis of the training data. The function can be in a discrete or in a continuous form. The discrete function can be presented as a table of average protein similarity values (such as RMSD) calculated for a selected set of the intervals of sequence similarity parameters. According to specific embodiments, such a function may require some minor corrections to achieve, for example, a monotone dependence on the parameters. It can be done by smoothing (via averaging) of non-monotonic regions using neighboring values.

According to other aspects of the invention, the continuous function can be produced by the linear regression analysis or, alternatively, by spline or other interpolation of the discrete function.

According to some embodiments the weighted resistance is calculated as expected dissimilarity (such as RMSD) between corresponding protein fragments. Other functions of the dissimilarity can be also used. For example, the measure of exponent of minus squared dissimilarity divided by squared standard deviation of the dissimilarity (as it proposed in “On spectral clustering: Analysis and an algorithm”, A. Y. Ng, M. I. Jordan, and Y. Weiss, Advances in Neural Information Processing Systems 14, page 849-856, MIT Press, (2001) which is incorporated herein in it's entirety) can be used. Alternatively, logarithm or other functions can be used.

In addition, a function calculating the probability of the fragments to be dissimilar (according to selected characteristics and selected threshold) can be used.

It is further within the scope to disclose the method as defined in any of the above, additionally comprising steps of selecting said weighting function from the group consisting of: a table of average protein similarity values calculated for said predetermined training data parameters, linear regression, monotonic regression, spline interpolation, discrete spline interpolation, polynomic approximation equation and any combination thereof.

It is further within the scope to disclose the method as defined in any of the above, additionally comprising steps of smoothing data of said discrete form function via an approximating function selected from a group consisting of: averaging, linear transformation, spline interpolation, monotonic regression, algorithms, density estimator, histogram, smoother matrix, convolution, moving average algorithm, scale space representation, additive smoothing, Butterworth filter, Digital filter, Kalman filter, Kernel smoother, Laplacian smoothing, Stretched grid method, Low-pass filter, Savitzky-Golay smoothing, Local regression, Smoothing spline, Ramer-Douglas-Peucker algorithm, Exponential smoothing, Kolmogorov-Zurbenko filter and any combination thereof.

It is further within the scope to disclose the method as defined in any of the above, wherein each of said plurality of subsequences is represented by a node in the protein network.

It is further within the scope to disclose the method as defined in any of the above, additionally comprises steps of calculating a plurality of distances between said nodes, said distance is calculated according to a protein sequence similarity property.

It is further within the scope to disclose the method as defined in any of the above, wherein said distance is calculated by a hamming distance function between said pair of subsequences represented by the two nodes.

It is further within the scope to disclose the method as defined in any of the above, additionally comprises steps of generating an edge between two nodes in the network when said hamming distance between the two nodes is lower than a predefined threshold hamming distance value for said protein similarity property.

It is further within the scope to disclose the method as defined in any of the above, wherein said edges in the network are calculated according to sequence similarity values of adjacent sequences to the nodes of said edge.

It is further within the scope to disclose the method as defined in any of the above, wherein said preexisting protein database comprises proteins with known structure.

It is further within the scope to disclose the method as defined in any of the above, wherein said weighting function is configured to calculate the distances of the edges in the network.

It is further within the scope to disclose the method as defined in any of the above, wherein said weighting function is derived from dependency of structural similarity attributes to similarity of sequences attributes.

It is further within the scope to disclose the method as defined in any of the above, further comprises steps of adding a fake edge to the protein network, said fake edge is correlated with a known protein similarity to a protein subsequence represented by a node in the protein network.

It is further within the scope to disclose the method as defined in any of the above, further comprises steps of calculating protein similarity values to said fake edge.

It is further within the scope to disclose the method as defined in any of the above, further comprises steps of converting the distances representing the edges into electrical attributes.

It is further within the scope to disclose the method as defined in any of the above, wherein said electrical attributes comprises resistance values.

It is further within the scope to disclose the method as defined in any of the above, further comprises steps of defining weighted protein relatedness based on resistance values between said subsequence pairs of said protein network.

It is further within the scope to disclose the method as defined in any of the above, further comprises steps of providing structural and/or functional annotation of a protein sequence by calculating the weighted relatedness between said protein sequence and annotated sequences.

It is further within the scope to disclose the method as defined in any of the above, further comprises steps of ranking a plurality of distances between a predetermined protein subsequence and annotated protein fragments.

It is further within the scope to disclose the method as defined in any of the above, additionally comprising steps of calculating sequence similarity in about 10 amino acid upstream and downstream said subsequence pairs.

It is further within the scope to disclose the method as defined in any of the above, wherein said protein sequence similarity threshold is about 60% sequence similarity.

It is further within the scope to disclose the method as defined in any of the above, additionally comprises steps of adding to said protein network additional nodes, wherein said additional nodes comprises protein fragments of about 20 aa derived from an annotated protein sequence database.

It is further within the scope to disclose a method for generating a weighted relatedness protein network comprising steps of:

a. obtaining a protein network;

b. generating training data comprising steps of;
i. obtaining a plurality of protein sequences with a known structure from a preexisting database;
ii. reducing redundancy of said plurality of protein sequences;
iii. dividing the protein sequences into a plurality of sub-sequences;
iv. defining a threshold value for protein sequence similarity;
v. generating a plurality of pairs of said subsequences, said subsequence pairs having a sequence similarity value above said predefined threshold;
vi. calculating training data comprising steps of:
   1. calculating the root mean square deviation (RMSD) value of structural similarity between each of said pairs of subsequences;
   2. calculating sequence similarity value between each of said pairs of subsequences and/or sequence similarity value between upstream and downstream sequences of said subsequences;

c. generating a weighting function derived from said training data configured for calculating weighted resistance between protein sequences;

d. applying said weighting function to a protein network, thereby generating a weighted resistance protein network.

It is further within the scope to disclose a method for predicting the degree of structural similarity of protein sequences comprising steps of:

a. obtaining a plurality of protein sequences;

b. dividing the protein sequences into a plurality of protein subsequences comprising 15 to 25 amino acids;

c. plotting average RMSD values of said subsequence pairs against amount of sequence mismatches in said fragment pairs;

d. plotting average RMSD values of said subsequence pairs against amount of sequence mismatches upstream and downstream sequences of said fragment pairs;

e. calculating the dependence of the amount of sequence matches of said subsequence pairs against the amino acid distance from said subsequence;

It is further within the scope to disclose a method for predicting structural similarity of proteins comprising steps of:

a. obtaining at least two predetermined protein sequences;

b. dividing the at least two protein sequences into a plurality of protein fragments comprising 15 to 25 amino acids;

c. defining a threshold value for protein sequence similarity;

d. generating a plurality of pairs of said fragments, said fragment pairs having a sequence similarity value above said predefined threshold;

e. calculating the slope of amount of sequence matches against amino acid distance from said 15 to 25 amino acid fragment thereby determining degree of similarity of said 15 to 25 amino acid fragments.

It is further within the scope to disclose a method for facilitating generating a weighted relatedness protein network comprising steps of:

a. obtaining a protein network;

b. generating training data comprising steps of;
i. obtaining a plurality of protein sequences from a preexisting protein database;
ii. reducing redundancy of said plurality of protein sequences;
iii. dividing the protein sequences into a plurality of subsequences;
iv. defining a threshold value for protein similarity;
v. generating a plurality of pairs of said subsequences, said subsequence pairs having a protein similarity value equal or above said predefined threshold;
vi. defining training data parameters for relatedness between said subsequence pairs;
vii. calculating the values of said training data parameters for said subsequence pairs;

c. generating a weighting function derived from said training data values said weighting function configured for calculating weighted relatedness of protein sequences.

It is further within the scope to disclose the method as defined in any of the above, additionally comprising steps of applying said weighted relatedness function to a protein network, thereby generating a weighted relatedness protein network.

It is further within the scope to disclose a method for optimizing predictions of structural similarity between proteins comprising steps of:

a. obtaining a protein network;

b. generating training data comprising steps of;
i. obtaining a plurality of protein sequences with a known structure from a preexisting database;
ii. reducing redundancy of said plurality of protein sequences;
iii. dividing the protein sequences into a plurality of sub-sequences;
iv. defining a threshold value for protein sequence similarity;
v. generating a plurality of pairs of said subsequences, said subsequence pairs having a sequence similarity value above said predefined threshold;
vi. calculating training data comprising steps of:
   1. calculating the root mean square deviation (RMSD) value of structural similarity between each of said pairs of subsequences;
   2. calculating the sequence similarity value in predetermined sized adjacent sequences of said subsequence pairs;

c. generating a weighting function derived from said training data configured for calculating weighted resistance between protein sequences;

d. applying said weighting function to said protein network;

e. plotting the number of correct structural similarity predictions against the size of said adjacent sequences taken into account in step 2, thereby obtaining a predictive power curve, peak of said curve defining optimal size of adjacent sequences needed to provide maximum correct predictions.

It is further within the scope to disclose a non transitory computer readable medium comprising instructions which, when implemented by one or more computers cause the one or more computers to present at a display unit of said one or more computers at least one of the following:

a. average RMSD values against amount of mismatches in 15 to 25 amino acid fragment pairs;

b. average RMSD values against amount of mismatches in upstream and downstream sequences of said fragment pairs;

c. slope of amount of sequence matches of said 15 to 25 amino acid fragment pairs against amino acid distance from said fragment; thereby determining degree of similarity of said 15 to 25 amino acid fragment pairs.

It is further within the scope to disclose a non transitory computer readable medium comprising instructions which, when implemented by one or more computers cause the one or more computers to present at a display unit of said one or more computers:

a weighting function derived from training data values, said training data values are calculated comprising steps of:

a. obtaining a plurality of protein sequences from a preexisting protein database;

b. reducing redundancy of said plurality of protein sequences;

c. dividing the protein sequences into a plurality of subsequences;

d. defining a threshold value for a predetermined protein similarity property;

e. generating a plurality of pairs of said subsequences, said subsequence pairs having a protein similarity value equal or above said predefined threshold;

f. defining training data parameters for weighting relatedness between said subsequence pairs;

g. calculating the values of said training data parameters for said subsequence pairs; said weighting function configured for calculating weighted relatedness of protein sequences.

It is further within the scope to disclose the non transitory computer readable medium as defined in any of the above, wherein said weighting function is applicable to any protein network, thereby generating a weighted relatedness protein network.

It is further within the scope to disclose a method for improving the prediction power of a preexisting protein network, comprising steps of:

a. obtaining a protein network; said protein network comprises a plurality of nodes, each of said nodes comprises a protein fragment of about 20 aa;

b. generating training data comprising steps of;
i. obtaining a plurality of protein sequences from a preexisting protein database;
ii. reducing redundancy of said plurality of protein sequences;
iii. dividing the protein sequences into a plurality of subsequences;
iv. defining a threshold value for protein sequence similarity;
v. generating a plurality of pairs of said subsequences, said subsequence pairs having a protein similarity value equal or above said predefined threshold;
vi. defining training data parameters for weighting relatedness between said subsequence pairs;
vii. calculating the values of said training data parameters for said subsequence pairs;

c. generating a weighting function derived from said training data values;

d. adding to said protein network additional nodes, wherein each of said additional nodes comprises a protein fragment of about 20 aa derived from an annotated protein sequence database;

e. generating a plurality of pairs of said additional nodes and said protein network plurality of sequences, said pairs having a protein similarity value equal or above said predefined threshold;

f. applying said weighting function to said protein network comprising said additional nodes, thereby improving the prediction power of said protein network.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

### EXAMPLE 1

Method For Generating A Weighted Relatedness Protein Network

Reference is now made to a non limiting example of some of the embodiments of the method of the present invention.

In the previous un-weighted methods, see [Frenkel Z. M., Snir S., etc. JTB, 260 (2009): 438-444] which is incorporated herein in it's entirety, all edges in a protein network are equal. The resistance between two remote nodes reflected only the amount of independent paths and their lengths, without taking into account the possible effects of properties of corresponding protein fragments. Evidently, it is shown by the present example that the probability of two neighboring nodes to be similar depends on sequence similarity of the correspondent sequences. One aim of the present invention is to build a weighting function, in which on the basis of input of two protein sequences would provide a probability of two protein fragments corresponding to nodes in the protein network to be similar.

Steps for calculation of weights for resistance or relatedness between protein sequences:

a. Obtain database of proteins with known protein structures; such as ASTRAL database (http://astral.berkeley.edu/);

b. Reduce redundancy of the database; for example by deletion of very similar sequences, proteins with the identical SCOPe classification codes etc;

c. Divide the proteins from the database into 20 amino acid (aa) fragments;

d. Define a threshold for sequence similarity, for example at least 60% sequence similarity or at least 12 matches in 20 aa fragment positions;

e. Generate pairs of the 20 aa fragments having sequence similarity value equal or above the predefined threshold;

f. Calculate structure similarity of the fragments in each pair, i.e. by calculating root mean square deviation (RMSD) values;

g. Calculate selected training data properties or features for each of the fragment pairs. In other words, metric or properties for similarity between the protein fragments should be selected. Non limiting examples of such training data properties include sequence similarity values, similar structure etc. Examples of selected sequence features for taking into account for weight calculation may include hamming distance, row-scores of one or some versions of standard protein sequence alignment, p- or e-values and many others. These parameters may be calculated for the nodes fragments, as well as for its adjacent (context) sequences. In this specific example, for each pair of fragments (generated in step e) value(s) of the sequence similarity metric(s) have been calculated.

h. Generate a weighting (edge resistance) function derived from the calculated training data. The weighting function can be in a discrete form or in a continuous form. An example of a discrete form is a table presenting sequence similarity values and correspondent expected (or average) RMSD values for each pair of 20 aa fragments. The weighting function can be in a polynomial form (of some degree k). The coefficients of the polynomial function can be extracted by the linear regression analysis. In another embodiment, calculation of average RMSD values takes into account match positions in the sequence and application of different other approaches such as spline interpolation, monotone regression, etc. may be selected.

Experimental Procedure:

In the current example, the following definitions are applied:

A node is defined as 20 amino acid fragment;

An edge is defined as pair of nodes with similarity (e.g. hamming distance) equal to or higher than 60% (i.e. at least 12 matches in 20 positions).

The following training data parameters have been calculated:

a) RMSD values for each pair of nodes (i.e. 20 aa fragments)

b) Similarity (amount of mismatches) between each pair of nodes (i.e. 20 aa fragments)

c) Similarity (amount of mismatches) of sequences adjacent to the node fragments.

d) The influence of the distance of the mismatches position in the adjacent sequences from the node fragment.

An improved protein network model was applied to the PCN connected components described previously in [Frenkel Z. M., Snir S., etc. JTB, 260 (2009): 438-444] which is incorporated herein in it's entirety. Only connected components with sizes of 100-5000 nodes were considered. The PCN contains thousands of nodes with known structure (i.e. these nodes where added to the network from protein database such as the ASTRAL database). It is herein demonstrated that the predictive power of the currently disclosed improved weighted relatedness protein network is significantly higher than the previous unweighted model.

Results

Example of training data is presented in Table 1. This table presents data of a comparison between two protein sequences (i.e. 1^{st} protein number #5 and 2^{nd} protein number #43) with known structures.

Each protein sequence has been divided into subsequences or fragments comprising 20 amino acids (aa). The fragments which were derived from the same protein are overlapping and each of the fragments begins with a subsequent amino acid (i.e. 1^{st} aa position number).

The training data presented in this table include: number of matches within the 20 aa fragments (i.e. matches inside), number of matches in 10 aa sequences upstream to the fragments (i.e. matches upstream), number of matches in 10 aa sequences downstream to the fragments (i.e. matches downstream) and RMSD values.

TABLE 1
Exemplary training data

| | 1^{st} aa posit. | | 1^{st} aa posit. | | | | |
|---|---|---|---|---|---|---|---|
| 1^{st} Prot. | numb. of 1^{st} | 2^{nd} Prot. | numb. of 2^{nd} | Matches | Matches | Matches | |
| numb. | Prot. | numb. | Prot. | inside | upstream | downstream | RMSD |
| 5 | 53 | 43 | 56 | 12 | 3 | 7 | 0.394905 |
| 5 | 54 | 43 | 57 | 13 | 3 | 6 | 0.390917 |
| 5 | 55 | 43 | 58 | 12 | 3 | 6 | 0.38348 |
| 5 | 56 | 43 | 59 | 12 | 3 | 6 | 0.375325 |
| 5 | 57 | 43 | 60 | 12 | 3 | 6 | 0.41671 |
| 5 | 58 | 43 | 61 | 12 | 3 | 6 | 0.407504 |
| . . . | . . . | . . . | . . . | . . . | . . . | . . . | . . . |

Such training data is herein used for calculation of a weighting function configured for determining relatedness between protein sequences. The weighting function is, for example, in a form of a discrete function or in a form of a continues function. One example of presenting the weighting function in a discrete form is Table 2. Table 2 presents calculation of average expected RMSD values based on the training data. It should be noted that the results presented in Table 2 have not been averaged or smoothed.

TABLE 2
Average calculated expected RMSD

| Mism. | Mism. inside | | | | | | | | |
|---|---|---|---|---|---|---|---|---|---|
| outside | 0 mism. | 1 mism. | 2 mism. | 3 mism. | 4 mism. | 5 mism. | 6 mism. | 7 mism. | 8 mism. |
| 0 | 0.40914 | 0.3603 | 0 | 0.44735 | 0 | 0.23821 | 0.34093 | 0.46585 | 0.4879 |
| 1 | 0.396 | 0.42602 | 0.36464 | 0.42224 | 0.3988 | 0.34244 | 0.32663 | 0.46201 | 0.49281 |
| 2 | 0.40018 | 0.34474 | 0.599 | 0.5259 | 0.89334 | 0.44889 | 0.38047 | 0.39615 | 0.34655 |
| 3 | 1.0235 | 0.46664 | 0.72317 | 0.84297 | 0.60217 | 0.524 | 0.51301 | 0.42326 | 0.47442 |
| 4 | 1.8869 | 0.46226 | 0.55608 | 0.66817 | 0.58878 | 0.48739 | 0.66797 | 0.50075 | 0.59486 |
| 5 | 0 | 0.71985 | 0.51815 | 0.56842 | 0.47254 | 0.54586 | 0.52693 | 0.585 | 0.57042 |
| 6 | 0.34226 | 0.91491 | 0.46613 | 0.5042 | 0.42178 | 0.5942 | 0.62347 | 0.58766 | 0.55188 |
| 7 | 0.38083 | 0.37922 | 0.51508 | 0.47453 | 0.53794 | 0.61287 | 0.64368 | 0.54997 | 0.60284 |
| 8 | 0.33642 | 0.22638 | 0.4604 | 0.51938 | 0.58684 | 0.59817 | 0.56772 | 0.57273 | 0.60838 |
| 9 | 0.31542 | 0.25891 | 0.41995 | 0.50482 | 0.49984 | 0.56457 | 0.55897 | 0.58914 | 0.66022 |
| 10 | 0.25489 | 0.28296 | 0.35108 | 0.49474 | 0.5342 | 0.53719 | 0.551 | 0.61208 | 0.65253 |
| 11 | 0 | 0.30981 | 0.36006 | 0.52885 | 0.5075 | 0.55145 | 0.57519 | 0.66263 | 0.76193 |
| 12 | 0.32405 | 0.29002 | 0.49724 | 0.50318 | 0.544 | 0.5425 | 0.61675 | 0.68503 | 0.85631 |
| 13 | 0 | 0.28069 | 0.67849 | 0.48984 | 0.5639 | 0.6032 | 0.64026 | 0.7552 | 0.9043 |
| 14 | 0 | 0.30701 | 0.51472 | 0.54053 | 0.55484 | 0.61255 | 0.7079 | 0.80243 | 0.95106 |
| 15 | 0 | 0.26763 | 0.39604 | 0.57205 | 0.6248 | 0.67127 | 0.74018 | 0.86603 | 0.99249 |
| 16 | 0.26516 | 0.25408 | 0.40589 | 0.64753 | 0.54265 | 0.68183 | 0.85949 | 0.83702 | 1.0953 |
| 17 | 0.25688 | 0.71551 | 1.45419 | 0.6238 | 0.56193 | 0.83468 | 0.852 | 0.94417 | 1.24122 |
| 18 | 0 | 0 | 0.27409 | 0.48371 | 0.56836 | 0.79517 | 0.8313 | 1.06411 | 1.48442 |
| 19 | 0 | 0 | 0.45256 | 0.52116 | 0.61545 | 0.57373 | 0.95357 | 1.24617 | 1.9106 |
| 20 | 0 | 0 | 0.40657 | 0.35155 | 0.26654 | 1.51584 | 1.11032 | 1.81146 | 2.13833 |

Mism. outside - amount of mismatches in 10 aa downstream and upstream sequences;
Mism. inside: 0 mism., 1 mism. etc - mismatches in the 20 aa fragments;
“0” - absence of such pairs in the training data.

It can be shown from Table 2 that the structural similarity of the protein fragments is affected by a correlation between the degree of sequence similarity of the fragment pairs and the number of mismatches in sequences adjacent to the fragment pairs.

It is demonstrated that up to a certain degree of sequence similarity of the fragment pairs, i.e. about 60% sequence similarity (about 8 mismatches within 20 aa fragment), the more mismatches found in the upstream and downstream sequences of the protein fragment pairs, the higher is the expected RMSD values of the fragment pairs. Thus the results provided by the present invention demonstrate that that up to a certain degree of sequence similarity, there is an opposite correlation between the amount of mismatches in sequences adjacent to the protein fragments of interest and the degree of structural similarity of the protein fragments.

Reference is now made to Table 3, presenting the amount of fragment pairs having a specific set of training data values, namely a specific number of mismatches within the 20aa fragment pairs and a specific number of mismatches within the 10aa upstream and downstream sequences adjacent to the fragment pairs.

TABLE 3
Amount of fragment pairs having a specific set of training data values

| | Mism. inside | | | | | | | | |
|---|---|---|---|---|---|---|---|---|---|
| Mism. outside | 0 mism. | 1 mism. | 2 mism. | 3 mism. | 4 mism. | 5 mism. | 6 mism. | 7 mism. | 8 mism. |
| 0 | 284 | 76 | 0 | 6 | 0 | 20 | 22 | 8 | 4 |
| 1 | 44 | 56 | 52 | 42 | 48 | 66 | 84 | 34 | 24 |
| 2 | 24 | 64 | 102 | 66 | 120 | 102 | 120 | 84 | 42 |
| 3 | 30 | 34 | 110 | 130 | 196 | 276 | 270 | 230 | 198 |
| 4 | 10 | 22 | 96 | 246 | 330 | 546 | 558 | 468 | 374 |
| 5 | 0 | 40 | 136 | 318 | 500 | 748 | 954 | 830 | 770 |
| 6 | 14 | 88 | 178 | 414 | 706 | 1084 | 1402 | 1468 | 1274 |
| 7 | 28 | 50 | 204 | 444 | 940 | 1342 | 1804 | 2008 | 1922 |
| 8 | 12 | 36 | 226 | 486 | 994 | 1640 | 2276 | 2618 | 2662 |
| 9 | 8 | 54 | 176 | 446 | 1012 | 1966 | 2738 | 3406 | 3636 |
| 10 | 4 | 30 | 162 | 410 | 1146 | 2132 | 3112 | 3692 | 4128 |
| 11 | 0 | 44 | 132 | 418 | 1104 | 2140 | 3312 | 4210 | 4514 |
| 12 | 2 | 18 | 116 | 432 | 1038 | 1930 | 3158 | 4406 | 4748 |
| 13 | 0 | 18 | 82 | 362 | 848 | 1672 | 2732 | 4018 | 4546 |
| 14 | 0 | 6 | 94 | 272 | 702 | 1460 | 2512 | 3374 | 4372 |
| 15 | 0 | 4 | 78 | 228 | 632 | 1298 | 1990 | 2780 | 3710 |
| 16 | 4 | 8 | 30 | 102 | 330 | 884 | 1296 | 2214 | 2906 |
| 17 | 8 | 4 | 26 | 110 | 228 | 436 | 928 | 1384 | 2514 |
| 18 | 0 | 0 | 2 | 26 | 108 | 316 | 474 | 1180 | 2192 |
| 19 | 0 | 0 | 6 | 8 | 88 | 122 | 248 | 638 | 1316 |
| 20 | 0 | 0 | 4 | 4 | 8 | 24 | 68 | 204 | 710 |

Table 3 shows that there is an optimal range of training data values combination, namely, number of mismatches within 20 aa protein fragments and number of mismatches in 10 aa upstream and downstream sequences of said fragments that should be used for weighting relatedness of protein sequences, i.e. structure relatedness.

Table 2 and Table 3 clearly demonstrate that a weighting function can be calculated by the method of the present invention using the disclosed training data parameters, as example of weighting parameters. In certain aspects of the present invention, other embodiments may be implemented in the current process such as interpolating the zero values by average values of neighboring cells or smoothing the data for obtaining monotonically growing values.

An alternative approach for calculating the weighting function of protein relatedness may be by using continues function for modeling the relationship between the training data variables. One example of such a function is a regression polynomial approximation function illustrated below:

R(X,Y)=RMSD value=a₀₀+a₁₀*X+a₀₁*Y+a₂₀*X²+a₁₁*X*Y+a₀₂*Y²+. . . +aₖ₀*X^{k}+aₖ₋₁₁X^{k-1}*Y+. . . +a₁ₖ₋₁*X*Y^{k-1}+a₀ₒₖ*Y^{k}

Where,

X is the amount of mismatches in the 20 aa protein fragments,

Y is the amount of mismatches in adjacent (upstream and downstream) sequences, normalized by the size of the adjacent sequence.

The equation above represents a linear regression function and the coefficient values aᵢⱼ can be calculated by a linear regression model (see for example http//en.wikipedia.org/wiki/Linear regression incorporated herein by its entirety) with the least squares approximation approach.

For example, the linear coefficient values calculated up to selected degree 4 are given in Table 4. It is noted that a₀₀ was taken zero.

TABLE 4
Linear coefficient values

| | | | | | |
|---|---|---|---|---|---|
| X | 4.988620 | X³ | −0.077099 | X³Y | 3.907079 |
| Y | 0.749856 | X²Y | 14.631268 | X²Y² | 1.659514 |
| X² | −13.062942 | XY² | −8.560862 | XY³ | 9.187311 |
| XY | −4.624481 | Y³ | −3.148726 | Y⁴ | 1.616582 |
| Y² | 1.234237 | X⁴ | 14.510658 | | |

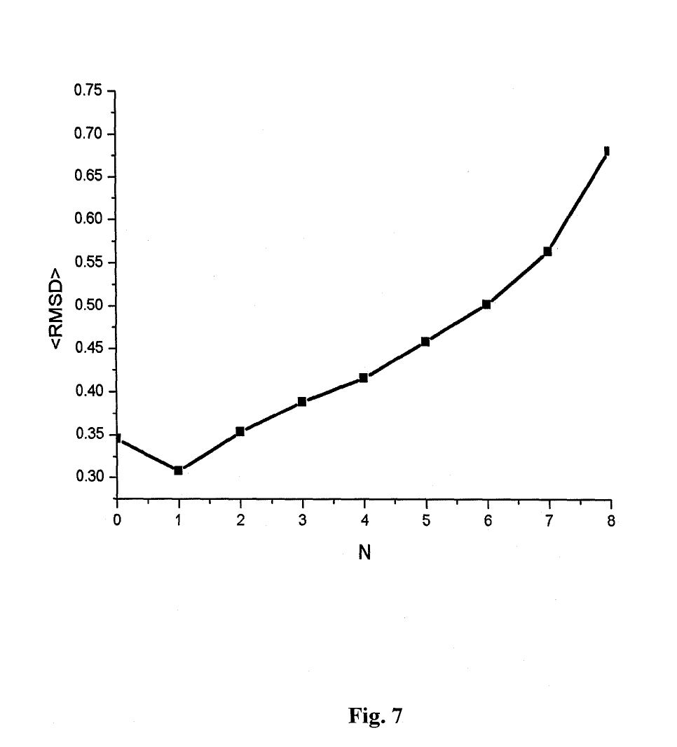

Reference is now made to FIG. 7 graphically presenting the dependence of average RMSD values on 20 aa fragment pairs similarity. In this figure the X axis defines as the amount of mismatches (N) in the 20 aa fragments, and the Y axis defines the average RMSD values. It can be seen from FIG. 7 that the greater the number of sequence mismatches within the fragment pairs, the higher are the structural differences (higher RMSD values) between the 20 aa fragment sequence pairs.

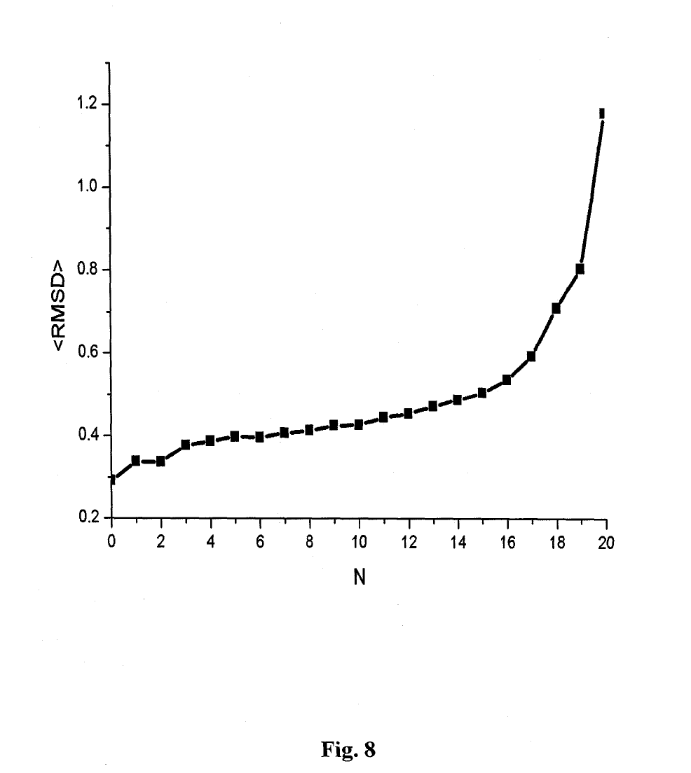

Reference is now made to FIG. 8 graphically presenting the dependence of average RMSD values on the similarity of sequences adjacent to the 20 aa protein fragments. In this figure the X axis defines as the amount of mismatches (N) in the 10 aa upstream and downstream sequences adjacent to the protein fragments, and the Y axis defines the average RMSD values. It can be seen from FIG. 8 that the greater the number of sequence mismatches in the adjacent sequences, the higher the structural differences are (higher RMSD values) between the 20 aa fragment sequence pairs.

In summary, FIGS. 7 and 8 demonstrate that average RMSD is dependent on the sequence similarity of the fragment pairs themselves (FIG. 7) and on the sequence similarity between the fragments adjacent sequences (FIG. 8, when the 10 amino acid regions upstream and downstream were considered).

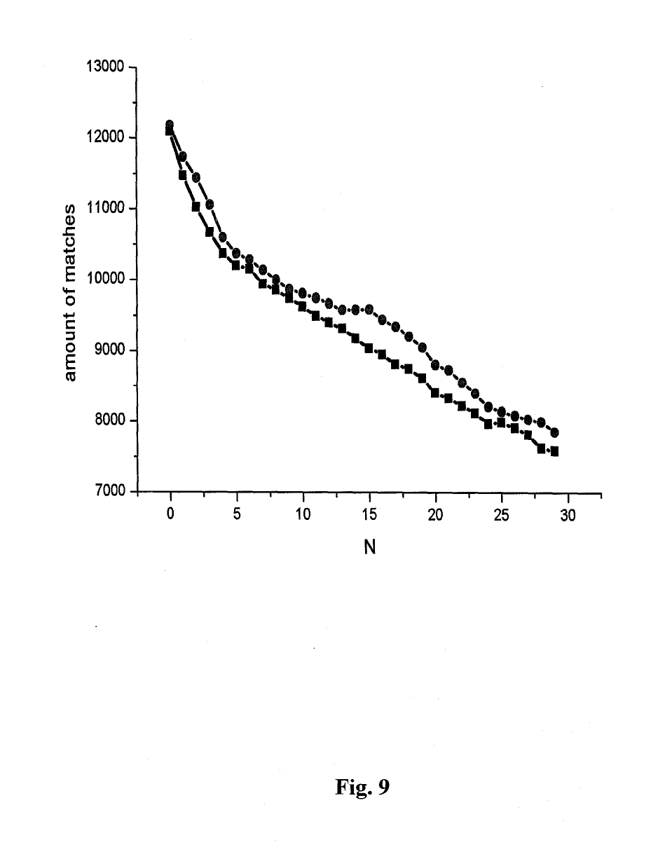

Reference is now made to FIG. 9 graphically describing the dependence of amount of matches (Y axis) on the amino acid position distance N (X axis) from the compared 20 aa fragments, for structurally similar (RMSD <3A) fragments. The line with the squares represents upstream positions, and the line with the triangles represents downstream positions. This figure shows that there is a monotonic opposite correlation between the distance from the 20 aa fragment, both upstream and downstream, and the amount of matches, in structurally similar (RMSD <3A) fragments.

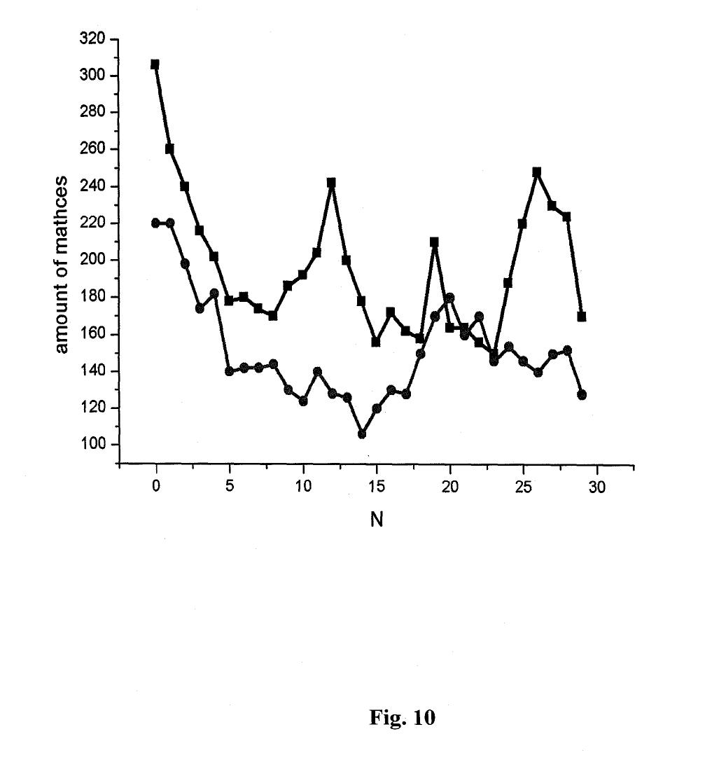

Reference is now made to FIG. 10 graphically describing the dependence of amount of matches (Y axis) on the amino acid position distance N (Y axis) from the compared 20 aa fragments, for structurally dissimilar (RMSD >3A) fragments. The line with the squares represents upstream positions, and the line with the triangles represents downstream positions. This figure shows a random correlation between the distance from the 20 aa fragment, both upstream and downstream, and the amount of matches, in structurally different (RMSD >3A) fragments.

Thus it can be concluded from FIGS. 9 and 10 that a monotonic dependence between the amount of matches and the distance from the fragment of interest is demonstrated for structurally similar fragments (RMSD <3A), whereas such dependence for structurally different fragments (RMSD >3A) is absent. This results can be used for predicting structural similarity of protein sequences (preferably between about 15 aa and about 25 aa), based on sequence similarity attributes.

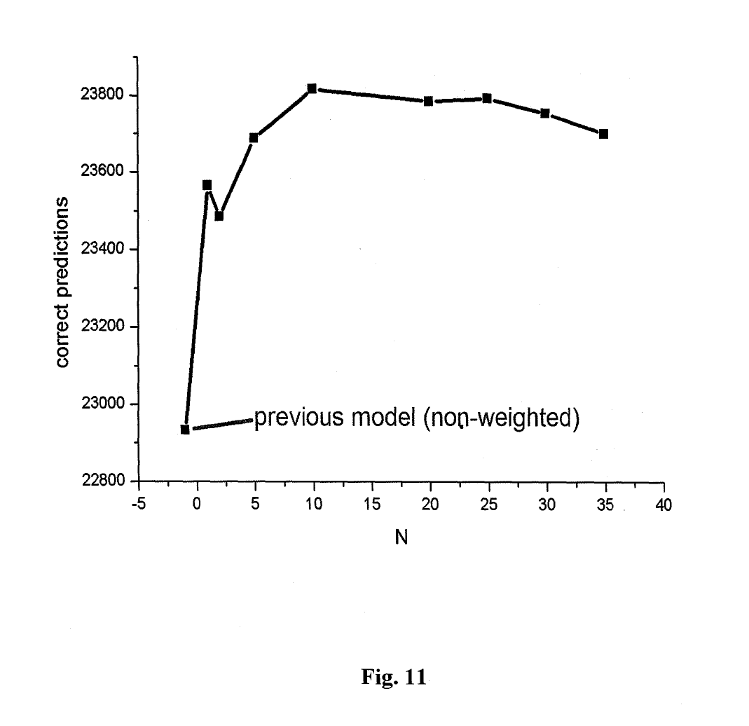

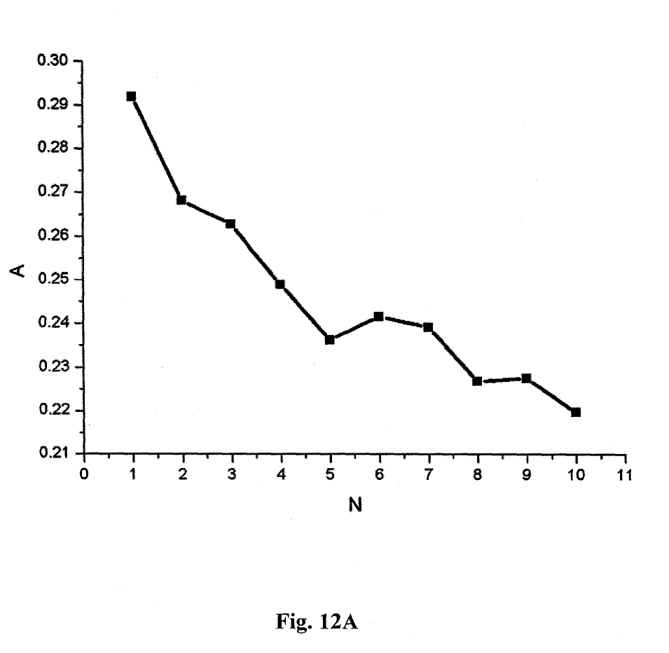

Reference is now made to FIG. 11 graphically describing the amount of correct predictions for the current weighting protein relatedness model against the aa size (N) of sequences adjacent to the protein fragments of interest taken into account, relative to previous non-weighted model.

It is submitted that similarly to [Frenkel Z. M., Snir S., etc. JTB, 260 (2009): 438-444], which is incorporated herein in it's entirety, from about 15,000 connected components (sizes of 100-5000 nodes) of the PCN, about 27,500 not neighboring pairs of nodes with known structure were extracted. The resistance through the network was calculated using edge resistances calculated by a selected model. For each pair of similar structures (RMSD <3A) probability of pairs with lower resistances to be similar was assigned as correct positive prediction, and for each pair of different structures probability of pairs with higher resistances to be different was assigned as correct negative prediction. Sum of positive and negative predictions for different models is plotted in FIG. 11.

It can be seen from FIG. 11 that the amount of correct predictions is increasing in positive correlation with the size of adjacent aa sequences taken into account up to a size threshold, where a plateau of the number of correct predictions is reached. In other words it can be seen in FIG. 11 that the more adjacent aa sequences taken into account, the more accurate are the predictions.

It should be noted that in other configurations, other or more parameters can be taken in to account. For example, in addition to the number of matches in the fragment of interest and in adjacent sequences, the position of the mismatch from the fragment of interest can be taken into account (see below). It is shown, that the closeness of the match in the adjacent sequence to the fragment is strongly correlated with a probability of correspondent structures to be similar. In this case the output weighting function can not be discrete. For modelling of such function a polynomic presentation with regression analysis or a spline interpolation can be used.

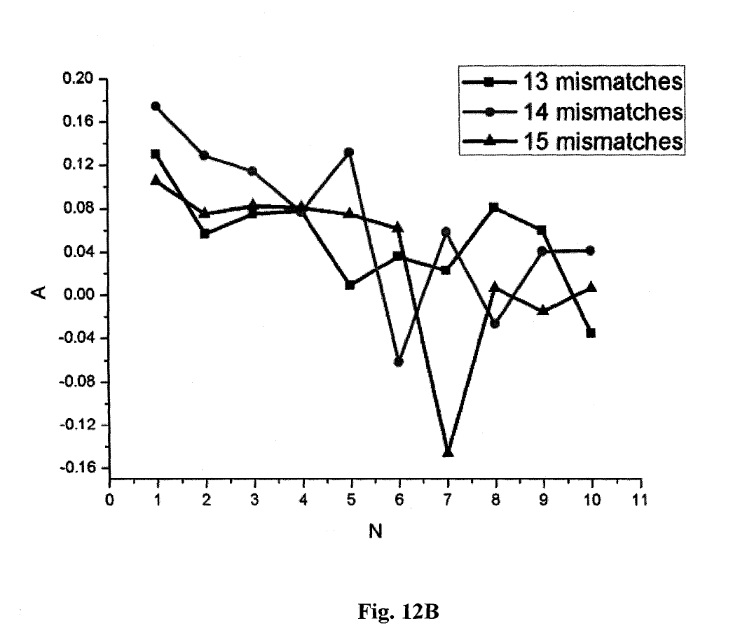

Reference is now made to FIG. 12A defining the following variables:

X axis defines aa position from the 20 aa fragment of interest;

Y axis defines differences between 2 matches (in correspondent positions upstream and downstream the fragment of interest) and 0 matches per aa position from the 20 aa fragment in average RMSD by Angstroms (A).

It is shown by this figure that in position 1, the average RMSD difference is highest (0.3 A).

In position 10, the average RMSD difference is lowest (0.22 A). In positions in between, the average RMSD difference decreases approximately proportionately.

It is proposed that the closer the adjacent aa position is to the 20 aa fragment of interest the greater the influence on average RMSD difference between 2 matches and 0 matches.

Reference is now made to FIG. 12B defining the following attributes:

X axis defines the aa position from the 20 aa fragment of interest;

Y axis defines the differences between 2 matches (in correspondent positions upstream and downstream the fragment of interest) and 0 matches per aa position.

In FIG. 12B each plot is of a preselected total number of mismatches in downstream and upstream adjacent aa sequences. The square line represents 13 mismatches, the circle line represents 14 matches and the triangle line represents 15 mismatches.

It can be seen from the results, that selected mismatches, analyzed separately still show that the closer the adjacent aa position is to the 20 aa fragment of interest the greater the influence on average RMSD difference between 2 matches and 0 matches.

Thus FIGS. 12A and B emphasize the importance of taking into account the position of matches in the adjacent sequences. Indeed, it is seen that the average difference between structures correspondent to matches and mismatches at correspondent position apparently decreases with moving away from the fragment.

To check the influence of taking into account the position of the matches on the structure prediction, the training data is divided into three cases: two matches at the first position upstream and downstream, one match at the first position upstream and downstream and no matches at the first position upstream and downstream. A table similar to Table 2 was calculated for each case. These results were used for calculation of weighted resistances in the PCN and estimation of the prediction quality. The results show that when the relative position of the matches is taken into account, the amount of correct predictions was higher than in the cases when this was not taken into account.

### EXAMPLE 2

The Contribution of Using Fake Edges

As previously described, the improved Protein Network Model was applied to the PCN connected components described in [Frenkel Z. M., Snir S., etc. JTB, 260 (2009): 438-444] which is incorporated herein in it's entirety. The protein network contains thousands of nodes (sequence fragments) of known structure. About 15,000 connected components of different sizes (100-5000 nodes) were considered. To measure an improvement of the model by use of fake edges the following procedure was run:
1. For each connected component was selected a pair of not-neighboring nodes with known 3D structure with RMSD between them less than 1.5A (if present). In the current example there are about 9,500 components containing such pairs (from the about 15,000).
2. New edges were added to the networks between the correspondent nodes with weighted resistance equal to the RMSD predefined value
3. For the identical sets of pair of not-neighboring nodes with known structures calculation of the resistances or relatedness through the network was done for two cases: with and without fake edges.
4. The amount of correct positive and negative predictions was calculated for both cases.

The amount of correct predictions for the case of fake edges is significantly higher than in the case where fake edges were not employed (more than 120 units of difference).

1-43. (canceled)

44. A method for generating a weighted relatedness protein network from a protein database comprising the steps of:
a. generating training data by;
i. obtaining a plurality of annotated protein sequences from a preexisting protein database;
ii. reducing redundancy of said plurality of protein sequences;
iii. dividing the protein sequences into a plurality of subsequences;
iv. defining a threshold value for protein sequence similarity;
v. generating a plurality of pairs of said subsequences, said subsequence pairs having a protein similarity value equal or above said predefined threshold;
vi. defining training data parameters for weighting relatedness between said subsequence pairs;
vii. calculating the values of said training data parameters for said subsequence pairs;
b. generating a function for calculating weight derived from said training data values; and
c. applying said weighting function to a protein network containing unannotated protein sequences, thereby generating a weighted relatedness protein network.

45. The method according to claim 44, wherein said protein subsequences comprise between about 15 to about 25 amino acids.

46. The method according to claim 44, additionally comprising the steps of selecting said preexisting protein database from a database classification group consisting of: structural, functional categories, physiological role, gene type, EC scheme, taxonomy of genes, taxonomy of pathways, taxonomy of reactions, taxonomy of ligand/compound, subcellular localization, protein classes, protein complexes, phenotypes, pathways, genetic element type, cellular role, molecular environment, genetic properties, post translational modifications, gene identification list, protein design and mutant stability and affinity prediction (EGAD), cellular roles, metabolic classification, cellular component, process, phylogenetic classification database and any combination thereof.

47. The method according to claim 44, additionally comprising steps of selecting said training data parameters for relatedness between said subsequence pairs from a group consisting of: functional similarity, structural similarity, spectral clustering, sequence similarity, solubility, hydrophobicity, electrical conduction, evolutionary ranking and any combination thereof.

48. The method according to claim 44, wherein said step of generating a function derived from said training data values additionally comprises steps of interpolating the zero values.

49. The method according to claim 44, wherein said step of generating a weighting function derived from said training data values additionally comprises steps of selecting said weighting function from the group consisting of: discrete form and continuous form.

50. The method according to claim 44, wherein each of said plurality of subsequences is represented by a node in the protein network.

51. The method according to claim 44, wherein said preexisting protein database comprises proteins with known structure.

52. The method according to claim 44, wherein said weighting function is configured to calculate the distances of the edges in the network.

53. The method according to claim 44, further comprises steps of defining weighted protein relatedness based on resistance values between said subsequence pairs of said protein network.

54. The method according to claim 44, further comprises steps of providing structural and/or functional annotation of a protein sequence by calculating the weighted relatedness between said protein sequence and annotated sequences.

55. The method according to claim 44, additionally comprising steps of calculating sequence similarity about 10 amino acids upstream and downstream of said 20 subsequence pairs.

56. The method according to claim 44, wherein said protein sequence similarity threshold is about 60% sequence similarity.

57. The method according to claim 44, additionally comprises steps of:
a. adding to said protein network additional nodes, wherein each of said additional nodes comprises protein fragments of about 20 aa derived from an annotated protein sequence database; and
b. generating a plurality of pairs of said additional nodes and between said additional nodes and said protein network plurality of sequences, said pairs having a protein similarity value equal or above said predefined threshold.

58. The method according to claim 47, additionally comprising steps of calculating said structural similarity by a measure selected from the group consisting of root mean square deviation (RMSD), exponent of minus squared dissimilarity divided by squared standard deviation, variance measure, probability distribution function, secondary structure assignment, native contact maps, residue interaction patterns, measures of side chain packing, measures of hydrogen bonds retention , dihedral angles of the protein backbones, minRMS, secondary structure elements (SSEs), TM score, TM-align, protein 3D structure alignment, Residue physic-chemical properties and any combination thereof.

59. The method according to claim 47, additionally comprising steps of calculating said sequence similarity of said subsequence pairs by calculating the sequence similarity within said subsequence pairs, calculating the sequence similarity between sequences adjacent to said subsequence pairs or by a combination thereof.

60. The method according to claim 47, additionally comprising steps of calculating said sequence similarity by a measure selected from the group consisting of: hamming distance, sequence alignment, BLAST, FASTA, SSEARCH, GGSEARCH, GLSEARCH, FASTM/S/F, NCBI BLAST, WU-BLAST, PSI-BLAST and any combination thereof.

61. The method according to claim 48, additionally comprises steps of interpolating the zero values by substituting the zero values by average values of neighboring non zero values.

62. The method according to claim 49, additionally comprising steps of selecting said weighting function from the group consisting of: a table of average protein similarity values calculated for said predetermined training data parameters, linear regression, monotonic regression, spline interpolation, discrete spline interpolation, polynomic approximation equation and any combination thereof.

63. The method according to claim 49, additionally comprising steps of smoothing data of said discrete form function via an approximating function selected from a group consisting of: averaging, linear transformation, spline interpolation, monotonic regression, algorithms, density estimator, histogram, smoother matrix, convolution, moving average algorithm, scale space representation, additive smoothing, Butterworth filter, Digital filter, Kalman filter, Kernel smoother, Laplacian smoothing, Stretched grid method, Low-pass filter, Savitzky-Golay smoothing, Local regression, Smoothing spline, Ramer-Douglas-Peucker algorithm, Exponential smoothing, Kolmogorov-Zurbenko filter and any combination thereof.

64. The method according to claim 50, additionally comprises steps of calculating a plurality of distances between said nodes, said distance is calculated according to a protein similarity property.

65. The method according to claim 50, further comprises steps of adding a fake edge to the protein network, said fake edge is correlated with a known protein similarity to a protein subsequence represented by a node in the protein network.

66. The method according to claim 50, further comprises steps of converting the distances representing the edges into electrical attributes.

67. The method according to claim 52, wherein said weighting function is derived from dependency of structural similarity attributes on similarity of sequences attributes.

68. The method according to claim 54, further comprises steps of ranking a plurality of distances between a predetermined protein subsequence and annotated protein fragments.

69. The method according to claim 64, wherein said distance is calculated by a hamming distance function between said pair of subsequences represented by the two nodes.

70. The method according to claim 65, further comprises steps of calculating protein similarity values to said fake edge.

71. The method according to claim 66, wherein said electrical attributes comprises resistance values.
